(19) United States
(12) Patent Application Publication
(10) Pub. No.: US 2022/0212685 A1
(43) Pub. Date: Jul. 7, 2022

(54) INFORMATION PROCESSING APPARATUS, MOVING APPARATUS, AND METHOD, AS WELL AS PROGRAM

(71) Applicant: Sony Semiconductor Solutions Corporation, Kanagawa (JP)

(72) Inventor: Eiji Oba, Tokyo (JP)

(73) Assignee: Sony Semiconductor Solutions Corporation, Kanagawa (JP)

(21) Appl. No.: 17/607,512

(22) PCT Filed: Apr. 6, 2020
(86) PCT No.: PCT/JP2020/015524

§ 371 Date: Oct. 29, 2021

(30) Foreign Application Priority Data
May 7, 2019 (JP) 2019-087571

(51) Int. Cl. B60W 50/10; B60W 50/00; B60W 60/00

(52) U.S. Cl. CPC B60W 50/10; B60W 50/0098; B60W 60/0015; B60W 2540/215; B60W 2554/4044; B60W 2540/21; B60W 2556/65

(57) ABSTRACT

A configuration that receives an intention of a user as input thereto and executes automatic driving control in which the intention of the user is reflected is implemented. A data processing unit that executes automatic driving control receives an intention of a user as input thereto and executes automatic driving control in which the intention of the user is reflected. The data processing unit executes an adjustment process of travel priority between an own vehicle that is a control target by automatic driving and a different vehicle different from the own vehicle. The data processing unit determines, on the basis of analysis of a travel environment, whether or not conflict in the same travel interval is to occur between the own vehicle and the different vehicle and checks, in a case where it is determined that conflict is to occur, the transfer intention of travel priority with the user and then executes the adjustment process.

### TECHNICAL FIELD

The present disclosure relates to an information processing apparatus, a moving apparatus, and a method, as well as a program. More particularly, the present disclosure relates to an information processing apparatus, a moving apparatus, and a method, as well as a program that make it possible for an automatic driving vehicle to execute automatic driving control in which an intention of a user such as a driver is reflected.

### BACKGROUND ART

In recent years, technology development related to automatic driving is being performed actively.

The automatic driving technology is a technology for making a vehicle (automobile) automatically travel on a road, with use of various sensors such as position detection means provided on the vehicle, and is expected to be popularized rapidly in the coming years.

In automatic driving, in addition to independence recognition of an environment with use of various sensors, advanced environmental map information called local dynamic map (LDM: Local Dynamic Map) is used to identify information necessary for travel of an own vehicle, and a course the own vehicle is to take is planned and decided to perform travel control of the vehicle.

Ordinary automatic driving control presupposes that control according to rules such as road regulations is performed. In other words, vehicle control that deviates from such rules prescribed by regulations is basically not executed.

On the other hand, in a case where a person controls a vehicle by manual driving (manual operation) to travel, the person sometimes transfers travel priority by yielding a travel road to a different vehicle or the like through visual observation of a situation of a surrounding environment or on the basis of experience memories. In such a case as just described, the person sometimes performs such travel as to enter an area in which travel is originally inhibited.

In such a manner, in a case where manual driving is performed, vehicle control that is not necessarily bound by legal rules is sometimes performed. Such flexible control makes it possible, for example, to prevent useless stopping or stagnation of vehicles in a road environment as a social infrastructure, securing smooth vehicle travel and social activities.

Although rule-based control in compliance with regulations seems to be efficient, there sometimes is a case in which, if the degree of freedom according to all surrounding factors including travel environments of a vehicle is secured, more efficient and smoother road use becomes possible.

For example, in a case where an automatic driving vehicle encounters an oncoming vehicle on a narrow street or the like, even if the vehicle is stopped, the vehicle blocks the travel road, resulting in occurrence of a dead end condition, by which the vehicle cannot move.

In the case of a manual driving vehicle, an experienced driver who can foresee such a situation as just described can take such a countermeasure as, for example, to stand by as the oncoming vehicle passes.

It is difficult to cause an automatic driving vehicle to automatically execute such a countermeasure as just described.

It is to be noted that, as a related art that discloses a control configuration that avoids such a situation as described above, for example, PTL 1 (Japanese Patent Laid-Open No. 2018-189616) is available.

This literature discloses a configuration that executes a process of estimating the speed of another vehicle that is approaching the own vehicle and decides a path of movement of the own vehicle.

Although this prior art is effective as a process for the other vehicle that is traveling toward the own vehicle, various situations occur during actual road travel, and the formulaic control described is not effective for all situations.

### CITATION LIST

### Patent Literature

### [PTL 1]

Japanese Patent Laid-Open No. 2018-189616

### SUMMARY

### Technical Problem

The present disclosure has been made, for example, in view of such a problem as described above, and it is an object of the present disclosure to provide an information processing apparatus, a moving apparatus, and a method, as well as a program that make it possible to execute, in an automatic driving vehicle that travels utilizing an automatic driving controlling system, automatic driving control in which an intention of a user such as a driver is reflected.

### Solution to Problem

A first aspect of the present disclosure resides in an information processing apparatus including a data processing unit that executes automatic driving control, in which the data processing unit includes an inputting unit to which an intention of a user is inputted and executes automatic driving control in which the intention of the user is reflected.

Further, a second aspect of the present disclosure resides in a moving apparatus, including an environment information acquisition unit that acquires environment information of the moving apparatus and a data processing unit that executes automatic driving control, in which the data processing unit determines a risk on a travel road according to the environment information acquired by the environment information acquisition unit, includes an inputting unit to which an intention of a user is inputted, and executes automatic driving control in which the intention of the user is reflected.

Further, a third aspect of the present disclosure resides in an information processing method executed by an information processing apparatus, in which the information processing apparatus includes a data processing unit that executes automatic driving control, and the data processing unit receives an intention of a user as input thereto and executes automatic driving control in which the intention of the user is reflected.

Further, a fourth aspect of the present disclosure resides in an information processing method executed by a moving apparatus, in which the moving apparatus includes an environment information acquisition unit that acquires environment information and a data processing unit that executes automatic driving control, and the data processing unit determines a risk on a travel road according to the environment information acquired by the environment information acquisition unit, receives an intention of a user as input thereto, and executes automatic driving control in which the intention of the user is reflected.

Furthermore, a fifth aspect of the present disclosure resides in a program for causing an information processing apparatus to execute information processing, in which the information processing apparatus includes a data processing unit that executes automatic driving control, and the program causes the data processing unit to receive an intention of a user as input thereto and execute automatic driving control in which the intention of the user is reflected.

It is to be noted that the program of the present disclosure is, for example, a program that can be provided by a storage medium and a communication medium provided in a computer-readable form to an information processing apparatus and a computer system that can execute various program codes. By providing such a program as just described in a computer-readable form, processing according to the program can be implemented on the information processing apparatus and the computer system.

Further objects, features, and advantages of the present disclosure will become apparent from more detailed description based on working examples of the present disclosure hereinafter described and the accompanying drawings. It is to be noted that, in the present specification, the term system is a logical aggregation configuration of plural apparatuses but is not limited to a configuration in which the component apparatuses are placed in the same housing.

According to a configuration of a working example of the present disclosure, a configuration that receives an intention of a user as input thereto and executes automatic driving control in which the intention of the user is reflected is implemented.

In particular, for example, the data processing unit that executes automatic driving control receives an intention of a user as input thereto and executes automatic driving control in which the intention of the user is reflected. The data processing unit executes an adjustment process of travel priority between an own vehicle that is a control target of automatic driving and a different vehicle different from the own vehicle. The data processing unit determines, on the basis of analysis of a travel environment, whether or not conflict in the same travel interval is to occur between the own vehicle and the different vehicle and checks, in a case where it is determined that conflict is to occur, the transfer intention of travel priority with the user and then executes the adjustment process.

By the present configuration, a configuration that receives an intention of a user as input thereto and executes automatic driving control in which the intention of the user is reflected is implemented.

It is to be noted that the advantageous effects described in the present specification are illustrative to the last and are not restrictive, and additional advantageous effects may be available.

### BRIEF DESCRIPTION OF DRAWINGS

FIG. 1 is a view illustrating an example of a configuration of a moving apparatus of the present disclosure.

FIG. 2 is a view illustrating an example of data displayed on a display unit of the moving apparatus of the present disclosure.

FIG. 3 is a view illustrating another example of data displayed on the display unit of the moving apparatus of the present disclosure.

FIG. 4 is a view illustrating an example of a configuration of the moving apparatus of the present disclosure.

FIG. 5 is a view illustrating an example of a configuration of the moving apparatus of the present disclosure.

FIG. 6 is a view illustrating an example of a sensor configuration of the moving apparatus of the present disclosure.

FIG. 7 is a view illustrating an example of a situation in which automatic driving control which is executed by the moving apparatus of the present disclosure and in which a driver intention is reflected is performed.

FIG. 8 is a view illustrating an example of a UI for inputting a driver intention for performing automatic driving control which is executed by the moving apparatus of the present disclosure and in which a driver intention is reflected.

FIG. 9 is a flow chart depicting an example of a processing sequence when automatic driving control in which a driver intention is reflected is performed.

FIG. 10 is a view illustrating an example of a situation in which automatic driving control which is executed by the moving apparatus of the present disclosure and in which a driver intention is reflected is performed.

FIG. 11 is a view illustrating an example of a UI for inputting a driver intention for performing automatic driving control which is executed by the moving apparatus of the present disclosure and in which a driver intention is reflected.

FIG. 12 is a view illustrating an example of a situation in which automatic driving control which is executed by the moving apparatus of the present disclosure and in which a driver intention is reflected is performed.

FIG. 13 is a view illustrating an example of a UI for inputting a driver intention for performing automatic driving control which is executed by the moving apparatus of the present disclosure and in which a driver intention is reflected.

FIG. 14 is a flow chart illustrating an example of a processing sequence when automatic driving control in which a driver intention is reflected is performed.

FIG. 15 is a flow chart illustrating another example of a processing sequence when automatic driving control in which a driver intention is reflected is performed.

FIG. 16 is a view illustrating an example of a hardware configuration of an information processing apparatus.

### DESCRIPTION OF EMBODIMENT

In the following, details of an information processing apparatus, a moving apparatus, and a method, as well as a program are described with reference to the drawings. It is to be noted that the description is given based on the following items.

1. Overview of configuration and processing of moving apparatus and information processing apparatus

2. Example of specific configuration and processing of moving apparatus

3. Necessity for automatic driving control in which driver intention is reflected

4. Specific examples of automatic driving control in which intention of driver is reflected

4-1 (Working example 1) Example of travel control when intruding vehicle into road through which automatic driving vehicle is passing appears

4-2 (Working example 2) Example of control that performs flexible countermeasure against existing traffic rules

4-3 (Working example 3) Example of control that performs flexible countermeasure for avoiding risk such as traffic jam

5. Sequence of processing executed by moving apparatus and information processing apparatus of present disclosure

6. Example of configuration of information processing apparatus

7. Summary of configuration of present disclosure

### 1. Overview of Configuration and Processing of Moving Apparatus and Information Processing Apparatus

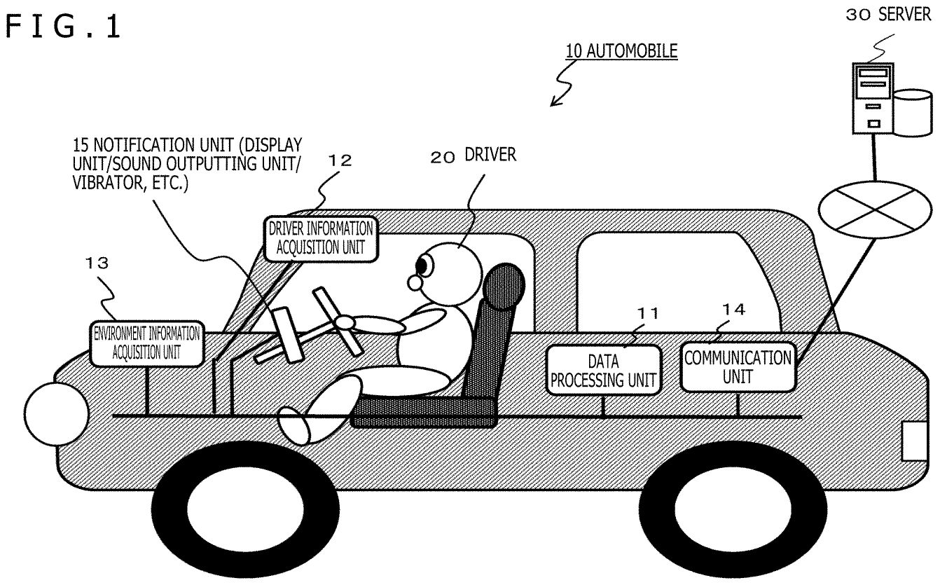

First, an overview of a configuration and processing of a moving apparatus and an information processing apparatus is described with reference to FIG. 1 and so forth.

The moving apparatus of the present disclosure is, for example, an automobile that can travel by switching between automatic driving and manual driving.

FIG. 1 is a view depicting an example of a configuration of an automobile 10 that is an example of the moving apparatus of the present disclosure. The information processing apparatus of the present disclosure is mounted on the automobile 10.

The automobile 10 depicted in FIG. 1 is an automobile that can travel in two driving modes including a manual driving mode and an automatic driving mode.

In the manual driving mode, the automobile 10 travels on the basis of an operation of a driver (operator) 20, that is, a steering wheel (steering) operation and an operation of an accelerator, a brake, or the like.

On the other hand, in the automatic driving mode, the automobile 10 does not need an operation by the driver 20 (driver) and travels on the basis of sensor information of, for example, a position sensor, other surrounding information detection sensors, and so forth.

The position sensor is, for example, a GPS receiver or the like, and the surrounding information detection sensors are, for example, a camera, an ultrasonic sensor, a radar, a LiDAR (Laser Imaging Determination and Ranging), a sonar, and so forth.

It is to be noted that FIG. 1 is a view illustrating an overview of the present disclosure and schematically depicts main components. A detailed configuration is hereinafter described.

As depicted in FIG. 1, the automobile 10 includes a data processing unit 11, a driver information acquisition unit 12, an environment information acquisition unit 13, a communication unit 14, and a notification unit 15.

The driver information acquisition unit 12 acquires, for example, information for determining a degree of wakefulness of the driver, operation information of the driver, and so forth. In particular, the driver information acquisition unit 12 includes, for example, a camera that captures a face image of the driver, operation information acquisition units for acquiring information regarding the operation units (steering wheel, accelerator, brake, and so forth), and so forth.

The environment information acquisition unit 13 acquires travel environment information of the automobile 10. For example, the environment information acquisition unit 13 acquires front, rear, left, and right image information of the automobile, position information acquired by the GPS, surrounding obstacle information from the LiDAR (Laser Imaging Detection and Ranging), sonar, and so forth, and other information.

The data processing unit 11 receives, as input information thereto, driver information acquired by the driver information acquisition unit 12 and environment information acquired by the environment information acquisition unit 13, and calculates a safety index value indicative of whether or not the driver in the inside of the vehicle during automatic driving is in a state in which the driver can execute safe manual driving, whether or not the driver during manual driving is executing safe driving, and so forth.

Further, for example, in a case where the necessity for switching from the automatic driving mode to the manual driving mode arises, the data processing unit 11 executes a process of giving a notice through the notification unit 15 such that switching to the manual driving mode is performed.

Furthermore, the data processing unit 11 issues an inquiry as to whether or not driving in which an intention of the driver 20 is reflected is to be executed during execution of automatic driving in the automatic driving mode, and executes travel control in which an intention of the driver is reflected, an adjustment process (negotiation) by communication with a different vehicle, or the like in response to input of the driver.

Specific examples of such processes as just described are hereinafter described in detail.

The notification unit 15 includes a display unit, a sound outputting unit, or a vibrator of the steering wheel or the seat that gives various notifications to the driver.

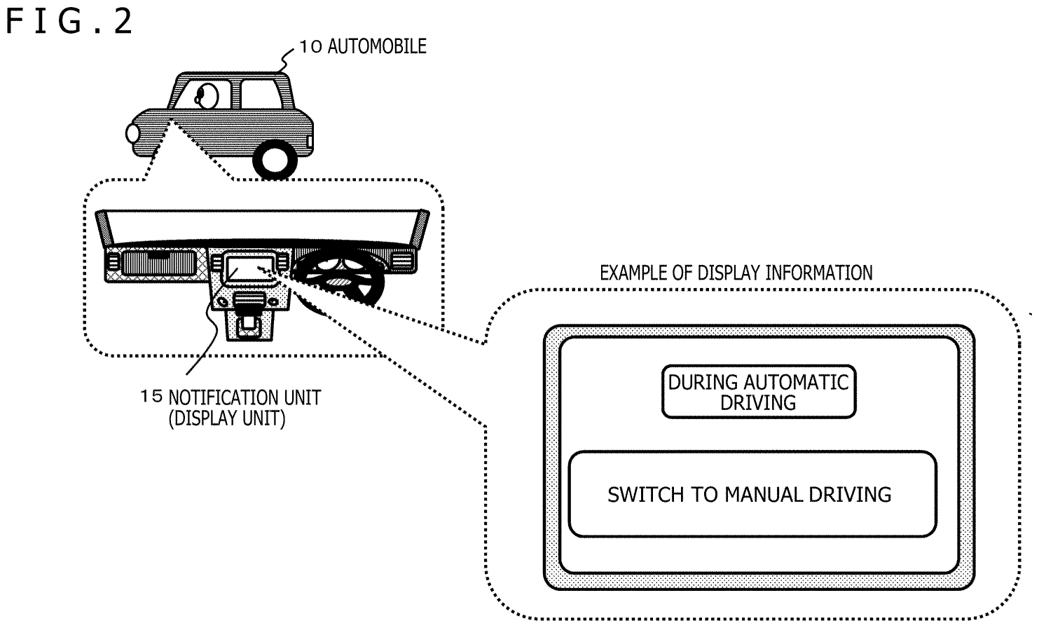

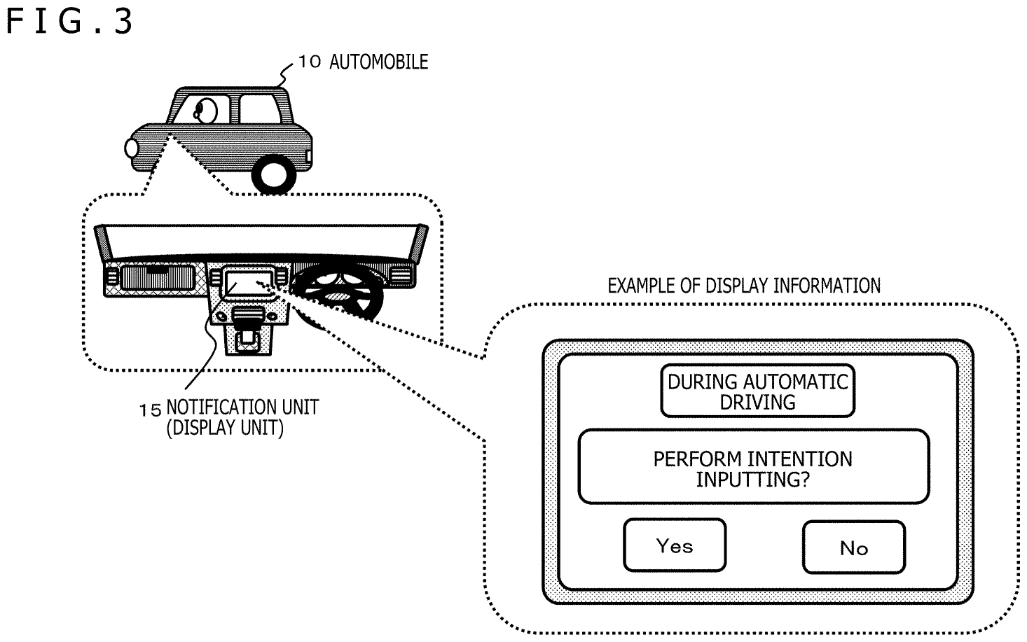

Examples of notification by the display unit configuring the notification unit 15 are depicted in FIGS. 2 and 3.

FIG. 2 depicts an example of a notification for requesting switching to manual driving during automatic driving.

As depicted in FIG. 2, a display unit 30 makes the following displays.

Driving mode information=“During automatic driving”

Warning display=“Switch to manual driving”

In the display area for driving mode information, upon execution of the automatic driving mode, the display of “During automatic driving” is made, and upon execution of the manual driving mode, the display of “During manual driving” is made.

FIG. 3 depicts an example of a notification to be given when an inquiry is issued to the driver as to whether or not control based on an intention of the driver is to be executed during automatic driving.

As depicted in FIG. 3, the display unit 30 makes the following displays.

Driving mode information=“During automatic driving”

Inquiry display=“Perform intention inputting?”

In a case where the displays are made, if a user (for example, the driver 20) inputs Yes, then the data processing unit 11 stands by as the user inputs his/her intention, and starts travel control, negotiation by communication with a different vehicle, or the like according to the inputted intention of the user.

The intention inputting of the user can be executed not only by inputting using a switch, a button, or the like but also by inputting using a touch panel provided on the display unit, inputting by a gesture, or similar inputting.

In the case of inputting by a gesture, a gesture imaged by the camera is analyzed by the data processing unit 11 to determine the user's intention.

Although the switch or the button is a conventional intention detection technology, the latest speech recognition or recognition interpretation thereof may be combined with artificial intelligence to perform intention interpretation of a more sophisticated written driver intention such that the driver intention is reflected in control of automatic driving. As an extreme example, a user may perform, for example, for the system during automatic travel control after setting an itinerary, such advanced cooperative intervention as, for example, “travel more slowly since the outside scenery is beautiful,” “give way to a vehicle that intrudes from the front,” “advance steadily without stopping since it is safe,” “decelerate to avoid danger,” “stop the vehicle since a grouse can be seen,” or “wait for passing of the leading car and then perform follow-up travel.”

It is to be noted that, as depicted in FIG. 1, the automobile 10 has a configuration capable of communicating with a server 30 through the communication unit 14.

The server 30 performs a process of providing a local dynamic map (LDM: Local Dynamic Map) that is advanced environmental map information that is updated sequentially so as to include real time traffic jam information, accident information, and so forth, a process of providing other traffic information, and so forth.

### 2. Example of Specific Configuration and Processing of Moving Apparatus

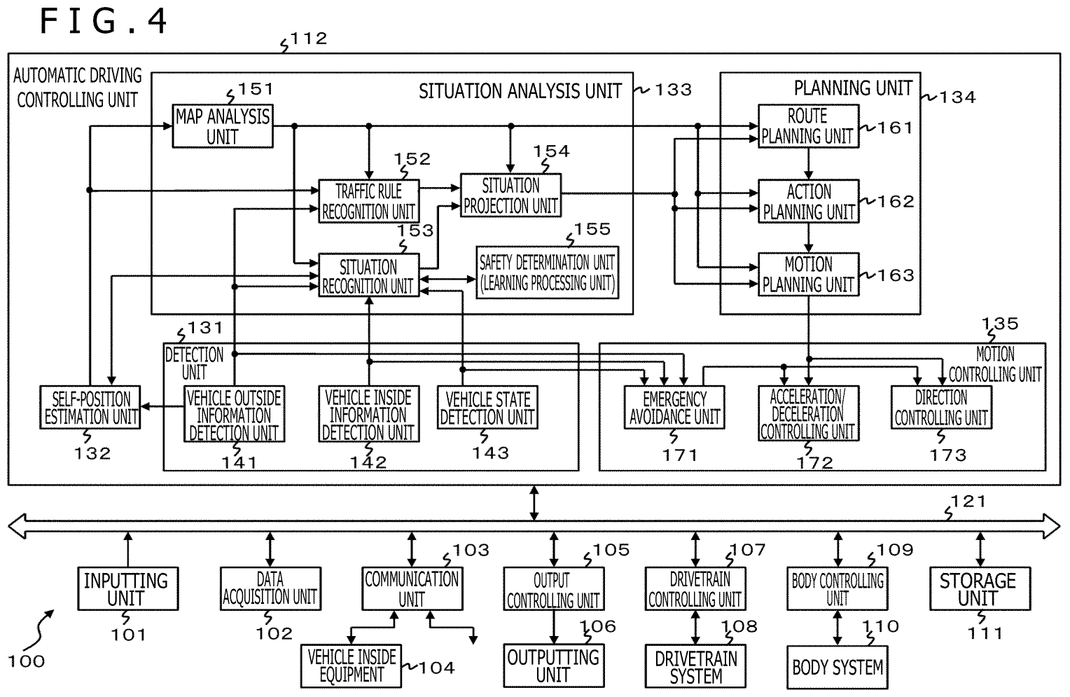

In the following, an example of a specific configuration and processing of the moving apparatus of the present disclosure is described with reference to FIG. 4 and so forth.

FIG. 4 depicts an example of a configuration of a moving apparatus 100. It is to be noted that, in a case where a vehicle in which the moving apparatus 100 is provided is to be distinguished from any other vehicle, it is referred to as an own car or an own vehicle.

The moving apparatus 100 includes an inputting unit 101, a data acquisition unit 102, a communication unit 103, vehicle inside equipment 104, an output controlling unit 105, an outputting unit 106, a drivetrain controlling unit 107, a drivetrain system 108, a body controlling unit 109, a body system 110, a storage unit 111, and an automatic driving controlling unit 112.

The inputting unit 101, the data acquisition unit 102, the communication unit 103, the output controlling unit 105, the drivetrain controlling unit 107, the body controlling unit 109, the storage unit 111, and the automatic driving controlling unit 112 are connected to each other through a communication network 121. The communication network 121 includes an in-vehicle communication network, a bus, or the like that complies with any standard such as a CAN (Controller Area Network), a LIN (Local Interconnect Network), a LAN (Local Area Network), or FlexRay (registered trademark), for example. It is to be noted that the components of the moving apparatus 100 are sometimes connected directly to each other without the intervention of the communication network 121.

It is to be noted that, in a case where the components of the moving apparatus 100 perform communication with each other through the communication network 121, reference to the communication network 121 is omitted. For example, in a case where the inputting unit 101 and the automatic driving controlling unit 112 communicate with each other through the communication network 121, this is described merely that the inputting unit 101 and the automatic driving controlling unit 112 communicate with each other.

The inputting unit 101 includes a device that is used by a passenger to input various kinds of data, instructions, and so forth. For example, the inputting unit 101 includes operation devices such as a touch panel, buttons, a microphone, switches, levers, and so forth, operation devices capable of inputting by a method other than a manual operation such as speech, gesture, and so forth, and similar devices. Further, for example, the inputting unit 101 may be a remote control device that uses infrared rays or some other radio waves or external connection equipment such as mobile equipment or wearable equipment ready for an operation of the moving apparatus 100. The inputting unit 101 generates an input signal on the basis of data, an instruction, or the like inputted by the passenger and supplies the input signal to the components of the moving apparatus 100.

The data acquisition unit 102 includes various sensors and so forth that acquire data to be used in processing of the moving apparatus 100 and supplies the acquired data to the components of the moving apparatus 100.

For example, the data acquisition unit 102 includes various sensors for detecting a state and so forth of the own car. In particular, the data acquisition unit 102 includes, for example, a gyro sensor, an acceleration sensor, an inertial measurement unit (IMU), sensors for detecting an operation amount of the accelerator pedal, an operation amount of the brake pedal, a steering angle of the steering wheel, an engine speed, a motor speed, a rotational speed of a wheel, or the like, and so forth.

Further, for example, the data acquisition unit 102 includes various sensors for detecting information of the outside of the own car. In particular, for example, the data acquisition unit 102 includes imaging devices such as a ToF (Time Of Flight) camera, a stereo camera, a monocular camera, an infrared camera, and other cameras. Further, for example, the data acquisition unit 102 includes environment sensors for detecting the weather, climate, and so forth and surrounding information detection sensors for detecting an object around the own car. The environment sensors include, for example, a raindrop sensor, a fog sensor, a sunlight sensor, a snow sensor, and so forth. The surrounding information detection sensors include, for example, an ultrasonic sensor, a radar, a LiDAR (Laser Imaging Detection and Ranging), a sonar, and so forth.

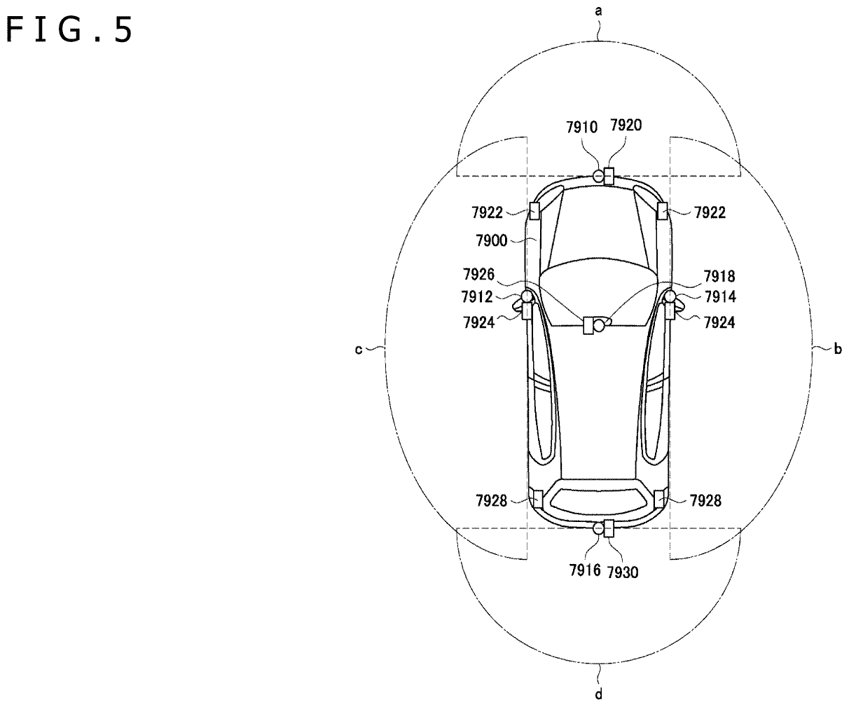

For example, FIG. 5 depicts an example of installation of various sensors for detecting outside information of the own car. Each of imaging devices 7910, 7912, 7914, 7916, and 7918 is provided at least at any one position of the front nose, side mirrors, rear bumper, backdoor, and an upper portion of the windshield in the vehicle interior of a vehicle 7900.

The imaging device 7910 provided on the front nose and the imaging device 7918 provided at an upper portion of the windshield in the vehicle interior acquire images mainly of the front of the vehicle 7900. The imaging devices 7912 and 7914 provided on the side mirrors acquire images mainly of the sides of the vehicle 7900. The imaging device 7916 provided on the rear bumper or the backdoor acquires an image primarily of the rear of the vehicle 7900. The imaging device 7918 provided at an upper portion of the windshield in the vehicle interior is used for detecting mainly a preceding vehicle or a pedestrian, an obstacle, a traffic signal, a traffic sign, a lane, or the like. Further, in future automatic driving, they may be applied for extended uses for detection of a crossing pedestrian on a left or right turn road that is present over a wide range when the vehicle is to turn right or left or further of a range of a crossing road approaching object.

It is to be noted that FIG. 5 depicts an example of imaging ranges of the imaging devices 7910, 7912, 7914, and 7916. The imaging range a indicates an imaging range of the imaging device 7910 provided on the front nose, and the imaging ranges b and c indicate imaging ranges of the imaging devices 7912 and 7914 provided on the side mirrors, respectively. Further, the imaging range d indicates an imaging range of the imaging device 7916 provided on the rear bumper or the backdoor. For example, by overlaying pieces of image data captured by the imaging devices 7910, 7912, 7914, and 7916, a bird's eye view image where the vehicle 7900 is viewed from above, an all-round stereoscopic display image where vehicle peripheral portions are surrounded by curved planes, and so forth can be obtained.

Sensors 7920, 7922, 7924, 7926, 7928, and 7930 provided on the front, rear, sides, and corners and an upper portion of the windshield in the vehicle interior of the vehicle 7900 may be, for example, ultrasonic sensors or radars. The sensors 7920, 7926, and 7930 provided on the front nose, rear bumper, or backdoor and an upper portion of the windshield in the vehicle interior of the vehicle 7900 may be, for example, LiDAR. The sensors 7920 to 7930 are used for detecting mainly a preceding vehicle, a pedestrian, an obstacle, and so forth. Detection results of them may be applied further to improvement of three-dimensional object display in the bird's eye view display and the all-round stereoscopic display.

Referring back to FIG. 4, description of the components is continued. The data acquisition unit 102 includes various sensors for detecting the current position of the own car. In particular, for example, the data acquisition unit 102 includes a GNSS (Global Navigation Satellite System) receiver and so forth for receiving GNSS signals from GNSS satellites and so forth.

Further, for example, the data acquisition unit 102 includes various sensors for detecting information of the vehicle inside. In particular, for example, the data acquisition unit 102 includes an imaging device for imaging the driver, a biological sensor for detecting biological information of the driver, a microphone for collecting sound in the vehicle interior, and so forth. The biological sensor is provided, for example, on the seat face, steering wheel, or the like and detects a sitting state of a passenger seated on the seat or biological information of the driver who holds the steering wheel. As a biological signal, diversification observable data of the heart rate, pulse rate, blood current, breath, mind-body correlation, visual stimulus, brain wave, perspiration condition, head posture behavior, eyes, gaze, blink, saccade, microsaccade, visual fixation, drift, fixed gaze, pupillary light reflect of the iris, and so forth. The biological activity observable information that reflects such observable driving states as described above is aggregated as observable evaluation values estimated from observations and is used for calculation of a return notification timing, which is a unique characteristic of a return delay case of the relevant driver, by a safety determination unit 155 hereinafter described, from a return delay time characteristic that is linked to logs of the evaluation values.

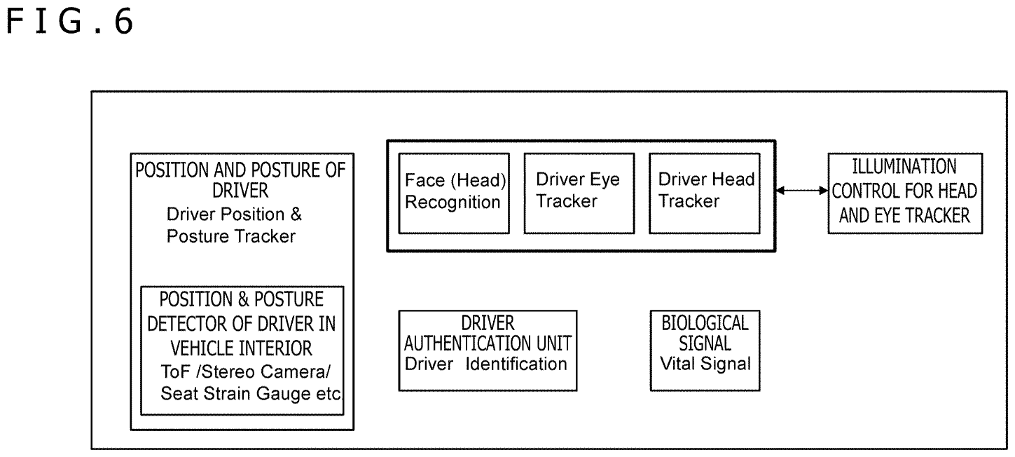

FIG. 6 depicts an example of various sensors included in the data acquisition unit 102 for obtaining information of the driver in the vehicle inside. For example, the data acquisition unit 102 includes, as detectors for detecting the position and the posture of the driver, a ToF camera, a stereo camera, a seat strain gauge (Seat Strain Gauge), and so forth. The data acquisition unit 102 further includes, as detectors for obtaining biological activity observable information of the driver, a face recognizer (Face (Head) Recognition), a driver eye tracker (Driver Eye Tracker), a driver head tracker (Drive Head Tracker), and so forth.

Further, the data acquisition unit 102 includes, as a detector for obtaining biological activity observable information of the driver, a biological signal (Vital Signal) detector. The data acquisition unit 102 further includes a driver authentication (Driver Identification) unit. It is to be noted that, as the authentication method, biometric information by the face, fingerprint, iris of the pupil, voice print, or the like may be applicable, in addition to knowledge identification by a password, a password number, or the like.

The communication unit 103 communicates with the vehicle inside equipment 104 and various kinds of equipment, servers, base stations, and so forth outside the vehicle, to transmit data supplied from the components of the moving apparatus 100 and supply received data to the components of the moving apparatus 100. It is to be noted that the communication protocol supported by the communication unit 103 is not particularly limited, and it is also possible for the communication unit 103 to support plural types of different communication protocols.

For example, the communication unit 103 performs wireless communication with the vehicle inside equipment 104 through a wireless LAN, Bluetooth (registered trademark), NFC (Near Field Communication), WUSB (Wireless USB), or the like. Further, for example, the communication unit 103 performs wired communication with the vehicle inside equipment 104 by a USB (Universal Serial Bus), HDMI (registered trademark) (High-Definition Multimedia Interface), MHL (Mobile High-definition Link), or the like through a connection terminal not depicted (as well as a cable if necessary).

For example, the communication unit 103 further performs communication with equipment (for example, an application server or a control server) present on an external network (for example, the Internet, a cloud network, or a network unique to a business company) through a base station or an access point. Further, for example, the communication unit 103 performs communication with a terminal present in the proximity of the own car (for example, a terminal of a pedestrian or a store or an MTC (Machine Type Communication) terminal), with use of the P2P (Peer To Peer) technology.

Further, for example, the communication unit 103 performs V2X communication such as vehicle to vehicle (Vehicle to Vehicle) communication, road-vehicle (Vehicle to Infrastructure) communication, communication between the own car and a home (Vehicle to Home), and pedestrian-vehicle (Vehicle to Pedestrian) communication. Further, for example, the communication unit 103 includes a beacon reception unit and receives a radio wave or an electromagnetic wave transmitted from a radio station or the like installed on a road, to acquire information of the current position, traffic jam, traffic regulation, required time, or the like. It is to be noted that pairing with a forward traveling vehicle during traveling in an interval in which it can become a leading vehicle may be performed through the communication unit such that information acquired from a data acquisition unit incorporated in the forward vehicle is acquired as previous travel information and is complemented with and used together with data of the data acquisition unit 102 of the own car. This becomes means for securing higher security of a following convoy especially in convoy traveling by a leading vehicle or the like.

The vehicle inside equipment 104 includes, for example, mobile equipment (tablet, smartphone, and so forth) or wearable equipment a passenger has, information equipment carried in or attached to the own car, a navigation apparatus that performs route search to any destination, and so forth. It is to be noted that, if it is taken into consideration that an occupant is not necessarily confined to a seated fixed position owing to widespread use of automatic driving, then the vehicle inside equipment 104 may be expanded to and used together with a game player, game equipment or other equipment that can be removed from vehicle-installation and used. In the present working example, an example in which information presentation of an intervention needing spot of a driver is limited to the pertaining driver is described. However, the information presentation may be further performed to a following vehicle in convoy traveling or the like or may be further used suitably in combination with remote travel support by normally giving information to an operation control center of passenger transport shared buses or long-distance logistics commercial vehicles.

The output controlling unit 105 controls outputting of various kinds of information to an occupant of the own car or to the vehicle outside. For example, the output controlling unit 105 generates an output signal that includes at least any one of visual information (for example, image data) and auditory information (four example, sound data) and supplies the output signal to the outputting unit 106 to control outputting of the visual information and the auditory information from the outputting unit 106. In particular, for example, the output controlling unit 105 combines pieces of image data captured by different imaging devices of the data acquisition unit 102 to generate a bird's eye image, a panorama image, or the like and supplies an output signal including the generated image to the outputting unit 106. Further, for example, the output controlling unit 105 generates sound data including warning sound, a warning message, or the like relating to such a danger as collision, contact, advancement into a dangerous zone, or the like, and supplies an output signal including the generated sound data to the outputting unit 106.

The outputting unit 106 includes a device capable of outputting visual information or auditory information to the occupant of the own car or to the vehicle outside. For example, the outputting unit 106 includes a display device, an instrument panel, an audio speaker, a headphone, a wearable device such as an eyeglasses type display that is worn by the occupant, a projector, a lamp, and so forth. The display device included in the outputting unit 106 may be a device that displays visual information in the field of view of the driver such as a head-up display, a transmission type display, or a device having an AR (Augmented Reality) display function, for example, in addition to an apparatus having an ordinary display.

The drivetrain controlling unit 107 generates and supplies various control signals to the drivetrain system 108 to perform control of the drivetrain system 108. Further, the drivetrain controlling unit 107 supplies control signals to components other than the drivetrain system 108 to perform notification and so forth regarding a control state of the drivetrain system 108, as occasion demands.

The drivetrain system 108 includes various devices relating to driving systems of the own car. For example, the drivetrain system 108 includes a driving force generation device for generating driving force such as an internal combustion engine or a driving motor, a driving force transmission mechanism for transmitting the driving force to the wheels, a steering mechanism for adjusting the steering angle, a brake device for generating braking force, an ABS (Antilock Brake System), an ESC (Electronic Stability Control), an electric power steering apparatus, and so forth.

The body controlling unit 109 generates and supplies various control signals to the body system 110 to perform control of the body system 110. Further, the body controlling unit 109 supplies control signals to components other than the body system 110 to perform notification and so forth regarding a control state of the body system 110, as occasion demands.

The body system 110 includes various devices for the body equipped in the vehicle body. For example, the body system 110 includes a keyless entry system, a smart key system, power window devices, power seats, a steering wheel, an air conditioning system, various lamps (for example, headlamps, back lamps, brake lamps, winkers, fog lamps, and so forth), and so forth.

The storage unit 111 includes, for example, a ROM (Read Only Memory), a RAM (Random Access Memory), a magnetic storage device such as an HDD (Hard Disc Drive), a semiconductor storage device, an optical storage device, a magneto-optical storage device, and so forth. The storage unit 111 stores various programs, data, and so forth to be used by the components of the moving apparatus 100. For example, the storage unit 111 stores map data of a three-dimensional high-precision map such as a dynamic map, a global map that is lower in accuracy but covers a wider area than the high-precision map, a local map that includes information around the own car, and so forth.

The automatic driving controlling unit 112 performs control relating to automatic driving such as autonomous driving or driving support. In particular, for example, the automatic driving controlling unit 112 performs cooperation control for achieving implementation of functions of an ADAS (Advanced Driver Assistance System) including collision avoidance or shock absorption of the own car, following travel based on the inter-vehicular distance, vehicle speed keeping travel, collision warning of the own car, warning of lane deviation of the own car, and so forth. Further, for example, the automatic driving controlling unit 112 performs cooperation control for the purpose of performing automatic driving and so forth for autonomously traveling without depending on an operation of the driver. The automatic driving controlling unit 112 includes a detection unit 131, a self-position estimation unit 132, a situation analysis unit 133, a planning unit 134, and a motion controlling unit 135.

The detection unit 131 performs detection of various kinds of information necessary for control of automatic driving. The detection unit 131 includes a vehicle outside information detection unit 141, a vehicle inside information detection unit 142, and a vehicle state detection unit 143.

The vehicle outside information detection unit 141 performs a process of detecting information of the outside of the own car on the basis of data or signals from the components of the moving apparatus 100. For example, the vehicle outside information detection unit 141 performs a detection process, a recognition process, and a tracing process for objects around the own car and a detection process for a distance and a relative speed to each object. The objects that become a detection target include, for example, a vehicle, a person, an obstacle, a structure, a road, a traffic signal, a traffic sign, a road sign, and so forth.

Further, for example, the vehicle outside information detection unit 141 performs a process of detecting an environment around the own car. The environments around the own car that become a detection target include, for example, the weather, temperature, humidity, brightness, a state of the road surface, and so forth. The vehicle outside information detection unit 141 supplies data indicative of a result of the detection process to the self-position estimation unit 132, a map analysis unit 151, a traffic rule recognition unit 152, and a situation recognition unit 153 of the situation analysis unit 133, an emergency avoidance unit 171 of the motion controlling unit 135, and so forth.

As the information to be acquired by the vehicle outside information detection unit 141, if the travel interval is an interval in regard to which a local dynamic map updated normally as an interval in which travel of automatic driving is intensively possible is supplied from the infrastructure, then it is possible to receive information supply mainly from the infrastructure, or prior to intrusion into the relevant interval, the own car may travel by constantly receiving information update in advance, from a vehicle or a vehicle group traveling precedingly in the relevant interval. Further, in such a case that update of the latest local dynamic map is not normally performed by the infrastructure, in order to obtain road information immediately before a safer intrusion interval especially in convoy traveling or the like, road environment information obtained from a leading vehicle intruding into an interval may be further used in a complementary manner. Whether or not automatic driving is possible in an interval depends in most cases upon whether or not there is such advance information provided from the infrastructure. Automatic driving availability information on a route provided from the infrastructure is equivalent to provision of an invisible track as what is generally called “information.” It is to be noted that, although the vehicle outside information detection unit 141 is depicted under the assumption that it is incorporated in the own vehicle, for the sake of convenience, pre-predictability upon travel may be further increased by using information obtained as the “information” by a preceding vehicle.

The vehicle inside information detection unit 142 performs a process of detecting information of the vehicle inside on the basis of data or signals from the components of the moving apparatus 100. For example, the vehicle inside information detection unit 142 performs an authentication process and a recognition process for the driver, a detection process for a state of the driver, a detection process for a passenger, a detection process for an environment of the vehicle inside, and so forth. States of the driver that become a detection target include, for example, a condition, a degree of wakefulness, a degree of concentration, a degree of fatigue, a gaze direction, an eyeball detailed behavior, and so forth.

Further, use of automatic driving in which the driver is fully free from a driving steering work is expected to be realized in the future, and it becomes necessary for the system to identify, where the driver snoozes temporarily or starts some other work, to which degree the return to wakefulness necessary for a driving return has progressed. In particular, although a driver monitoring system supposed in prior art mainly uses detection means for checking decline in consciousness by sleepiness or the like, since a state in which the driver does not intervene at all in driving steering is expected to be realized in future, the system loses means for observing the driving intervention degree of the driver directly from steering stability of a steering equipment and so forth. Thus, it is necessary for the system to observe consciousness return transition necessary for driving from a state in which an accurate consciousness state of the driver is unclear, identify the accurate internal awake state of the driver, and then proceed with intervention transfer from automatic driving of steering to manual driving.

Thus, the vehicle inside information detection unit 142 mainly has two staged great roles; the first role is passive monitoring of the state of the driver during automatic driving, and the second role is to perform detection and determination regarding surrounding recognition, perception, and determination of the driver and the operation capacity of the steering equipment up to a level at which manual driving becomes possible after a demand for return is issued from the system until an interval for driving under caution is reached. As the control, failure self-diagnosis of the entire vehicle may be performed further, and also in a case where functional deterioration of automatic driving is caused by partial functional failure in the automatic driving, a suggestion to the driver for quickly returning to manual driving may be issued similarly. The passive monitoring here designates detection means of a type that does not request the driver for a conscious response reaction but does not exclude means that emits a physical radio wave, light or the like from equipment to detect a response signal. In other words, the passive monitoring designates state monitoring of the driver who is unconscious due to a nap or the like, and a category that does not require a recognition response reaction of the driver is determined as a passive type. An active response device that analyzes and evaluates a reflection or spread signal upon application of a radio wave, infrared rays, or the like is not excluded. In contrast, means that requests a conscious response for requesting the driver for a response reaction is determined active.

The environments in the vehicle inside that become a detection target include, for example, an air temperature, humidity, brightness, smell, and so forth. The vehicle inside information detection unit 142 supplies data indicative of a result of the detection process to the situation recognition unit 153 of the situation analysis unit 133 and the motion controlling unit 135. It is to be noted that, in a case where it becomes clear, after a driving return instruction is issued from the system to the driver, that the driver cannot achieve manual driving within an exact time limit and it is determined that, even if a deceleration process is performed to give time grace while in automatic driving, transfer cannot be performed in time, the vehicle inside information detection unit 142 issues an instruction to the emergency avoidance unit 171 and so forth of the system to start a deceleration and refuging-stopping procedure to perform refuge of the vehicle. In short, even if an initial state is a situation in which the transfer cannot be performed in time similarly, by starting deceleration of the vehicle at an early stage, a period of time in which the transfer limit is reached can be created.

The vehicle state detection unit 143 performs a process of detecting a state of the own car on the basis of data or signals from the components of the moving apparatus 100. The states of the own car that become a detection target include, for example, a speed, acceleration, a steering angle, presence/absence and contents of abnormality, a state of a driving operation, a position and an inclination of a power seat, a door lock state, a state of in-vehicle equipment, and so forth. The vehicle state detection unit 143 supplies data indicative of a result of the detection process to the situation recognition unit 153 of the situation analysis unit 133, the emergency avoidance unit 171 of the motion controlling unit 135, and so forth.

The self-position estimation unit 132 performs a process of estimating the position, posture, and so forth of the own car on the basis of data or signals from the components of the moving apparatus 100 such as the vehicle outside information detection unit 141, the situation recognition unit 153 of the situation analysis unit 133, and so forth. Further, the self-position estimation unit 132 generates a local map to be used for estimation of the self-position (hereinafter referred to as a self-position estimation map) as occasion demands.

The self-position estimation map is a high-precision map created using a SLAM (Simultaneous Localization and Mapping) technique or the like. The self-position estimation unit 132 supplies data indicative of a result of the estimation process to the map analysis unit 151, the traffic rule recognition unit 152, and the situation recognition unit 153 of the situation analysis unit 133 and so forth. Further, the self-position estimation unit 132 causes the self-position estimation map to be stored into the storage unit 111.

The situation analysis unit 133 performs a process of analyzing the own car and the surroundings. The situation analysis unit 133 includes the map analysis unit 151, the traffic rule recognition unit 152, the situation recognition unit 153, a situation projection unit 154, and a safety determination unit 155.

The map analysis unit 151 performs an analysis process for various maps stored in the storage unit 111 while using data or signals from the components of the moving apparatus 100 such as the self-position estimation unit 132 and the vehicle outside information detection unit 141 as occasion demands, to construct a map including information necessary for processing of automatic driving. The map analysis unit 151 supplies the constructed map to the traffic rule recognition unit 152, the situation recognition unit 153, and the situation projection unit 154 as well as a route planning unit 161, an action planning unit 162, and a motion planning unit 163 of the planning unit 134 and so forth.

The traffic rule recognition unit 152 performs a recognition process for traffic rules around the own car on the basis of data and signals from the components of the moving apparatus 100 such as the self-position estimation unit 132, the vehicle outside information detection unit 141, and the map analysis unit 151. By this recognition process, the traffic rule recognition unit 152 recognizes, for example, positions and states of signals around the own car, contents of traffic regulations around the own car, a lane along which the own car can travel, and so forth. The traffic rule recognition unit 152 supplies data indicative of a result of the recognition process to the situation projection unit 154 and so forth.

The situation recognition unit 153 performs a recognition process for a situation relating to the own car, on the basis of data or signals from the components of the moving apparatus 100 such as the self-position estimation unit 132, the vehicle outside information detection unit 141, the vehicle inside information detection unit 142, the vehicle state detection unit 143, and the map analysis unit 151. For example, the situation recognition unit 153 performs a recognition process for a situation of the own car, a situation around the own car, a situation of the driver of the own car, and so forth. Further, the situation recognition unit 153 generates a local map (hereinafter referred to as a situation recognition map) to be used for recognition of a situation around the own car, as occasion demands. The situation recognition map is, for example, an occupied grid map (Occupancy Grid Map).

The situations of the own car that become a recognition target include, for example, conditions unique to a vehicle such as a position, a posture, and a movement (for example, a speed, acceleration, a moving direction, and so forth) of the own car as well as a cargo loading amount by which a motion characteristic of the own vehicle is determined and a movement of the center of gravity of the vehicle body by freight loading, a tire pressure, a braking distance movement by a wear situation of a brake pad, allowable maximum deceleration braking for preventing cargo movement that causes load braking, a centrifugal relaxation limit speed upon travel of a curve that is caused by a liquid loaded object, and so forth and conditions unique to the loaded cargo. Further, even if the road condition is quite the same in terms of the coefficient of friction, a road curve, and a gradient of the road surface, since the return starting timing that is required for control differs depending upon the characteristics of the vehicle itself, the load, and so forth, it is necessary to collect and learn such various conditions and reflect them at an optimum timing at which control is to be performed. It is not sufficient to simply observe and monitor presence/absence, contents, and so forth of abnormality of the own vehicle in order to determine a control timing depending upon the type of the vehicle, load, and so forth. In transportation industries and so forth, a parameter for determining addition of a grace time period for return desirable for securing certain safety may be set as a fixed value in advance depending upon the characteristic unique to the load, and a method of determining all notification timing deciding conditions uniformly by self-cumulative learning is not necessarily required to be taken.

The situations around the own car that become a recognition target include, for example, a kind and a position of surrounding stationary objects, a type, a position, and a movement (for example, a speed, acceleration, a moving direction, and so forth) of surrounding moving objects, a configuration of surrounding roads, a state of the road surface of the roads, a climate, an air temperature, humidity, and brightness of the surroundings, and so forth. The states of the driver that become a recognition target include, for example, a physical condition, a degree of wakefulness, a degree of concentration, a degree of fatigue, a movement of a gaze direction, a driving operation, and so forth. In order to cause the vehicle to travel safely, the control start point at which a countermeasure is demanded differs much depending upon the loading amount loaded in a unique state of the vehicle, a chassis fixed state of the mounting portion, an unbalanced state of the center of gravity, a maximum deceleration possible acceleration value, a maximum loadable centrifugal force, a return response delay amount according to a state of the driver, and so forth.

The situation recognition unit 153 supplies data indicative of a result of the recognition process (including a situation recognition map as occasion demands) to the self-position estimation unit 132, the situation projection unit 154, and so forth. Further, the situation recognition unit 153 stores the situation recognition map into the storage unit 111.

The situation projection unit 154 performs a projection process for a situation related to the own car on the basis of data or signals from the components of the moving apparatus 100 such as the map analysis unit 151, the traffic rule recognition unit 152, and the situation recognition unit 153. For example, the situation projection unit 154 performs a projection process for a situation of the own car, a situation around the own car, a situation of the driver, and so forth.

The situations of the own car that become a projection target include, for example, a behavior of the own car, occurrence of abnormality, a travelable distance, and so forth. The situations around the own car that become a projection target include, for example, a behavior of moving objects around the own car, a change in state of traffic signals, a change in environment such as the weather, and so forth. The situations of the driver that become a projection target include, for example, a behavior and a physical condition of the driver and so forth.

The situation projection unit 154 supplies data indicative of a result of the projection process to the route planning unit 161, the action planning unit 162, and the motion planning unit 163 of the planning unit 134 and so forth together with the data from the traffic rule recognition unit 152 and the situation recognition unit 153.

The safety determination unit 155 learns an optimum return timing according to a return action pattern of the driver, a vehicle characteristic, and so forth and provides the learned information to the situation recognition unit 153 and so forth. This makes it possible to present, to the driver, an optimum timing that is determined statistically as being necessary for the driver to normally return from automatic driving to manual driving at a ratio equal to higher than a prescribed fixed level.

The route planning unit 161 plans a route to a destination on the basis of data or signals from the components of the moving apparatus 100 such as the map analysis unit 151 and the situation projection unit 154. For example, the route planning unit 161 sets a route from the current position to a designated destination on the basis of the global map. Further, for example, the route planning unit 161 suitably changes the route on the basis of a situation of traffic jam, a traffic accident, traffic regulations, or a construction work, a physical condition of the driver, and so forth. The route planning unit 161 supplies data indicative of the planned route to the action planning unit 162 and so forth.

The action planning unit 162 plans an action of the own car for traveling on the route planned by the route planning unit 161 safely within the planned period of time, on the basis of data or signals from the components of the moving apparatus 100 such as the map analysis unit 151 and the situation projection unit 154. For example, the action planning unit 162 performs planning of start, stop, an advancing direction (for example, forward, backward, left turn, right turn, turn around, or the like), a travel lane, a travel speed, outstrip, and so forth. The action planning unit 162 supplies data indicative of the planned action of the own car to the motion planning unit 163 and so forth.

The motion planning unit 163 plans motion of the own car for implementing the action planned by the action planning unit 162, on the basis of data or signals from the components of the moving apparatus 100 such as the map analysis unit 151 and the situation projection unit 154. For example, the motion planning unit 163 performs planning of acceleration, deceleration, a travel track, and so forth. The motion planning unit 163 supplies data indicative of the planned motion of the own car to an acceleration/deceleration controlling unit 172, a direction controlling unit 173, and so forth of the motion controlling unit 135.

The motion controlling unit 135 performs control of motion of the own car. The motion controlling unit 135 includes the emergency avoidance unit 171, the acceleration/deceleration controlling unit 172, and the direction controlling unit 173.

The emergency avoidance unit 171 performs a detection process for such an emergency as collision, contact, entry into a dangerous zone, abnormality of the driver, abnormality of the vehicle, and so forth on the basis of results of detection by the vehicle outside information detection unit 141, the vehicle inside information detection unit 142, and the vehicle state detection unit 143. In a case where the emergency avoidance unit 171 detects occurrence of an emergency, it plans motion of the own car for avoiding the emergency such as a sudden stop or a sharp turn. The emergency avoidance unit 171 supplies data indicative of the planned motion of the own car to the acceleration/deceleration controlling unit 172, the direction controlling unit 173, and so forth.

The acceleration/deceleration controlling unit 172 performs acceleration/deceleration control for implementing the motion of the own car planned by the motion planning unit 163 or the emergency avoidance unit 171. For example, the acceleration/deceleration controlling unit 172 calculates a control target value for the driving force generation apparatus or the brake system for implementing the planned acceleration, deceleration, or sudden stop, and supplies a control instruction indicative of the calculated control target value to the drivetrain controlling unit 107. It is to be noted that mainly there are two cases in which an emergency can occur. In particular, the cases include a case in which, during automatic driving on a road that has originally been determined safe on a local dynamic map or the like acquired from the infrastructure in the travel route during automatic driving, an unanticipated accident occurs due to an unexpected reason and emergency return is not performed in time and another case in which it is difficult for the driver to precisely return from automatic driving to manual driving.

The direction controlling unit 173 performs direction control for implementing the motion of the own car planned by the motion planning unit 163 or the emergency avoidance unit 171. For example, the direction controlling unit 173 calculates a control target value for the steering apparatus for implementing the travel track or sharp turn planned by the motion planning unit 163 or the emergency avoidance unit 171 and supplies a control instruction indicative of the calculated control target value to the drivetrain controlling unit 107.

### 3. Necessity for Automatic Driving Control in which Intention of Driver is Reflected

The present disclosure makes it possible for an automatic driving vehicle to execute control in which a driver intention is reflected.

The information processing apparatus and the moving apparatus of the present disclosure perform travel control according to an intention of a user (driver), which is checked, for example, by an automatic driving controlling system. Further, the apparatuses check an intention of the driver also in a case in which a request for priority travel or the like that is different from prescribed traffic rules is received from the outside such as an oncoming vehicle. Furthermore, the apparatuses perform travel control for advancement to or travel or stop on a route different from an ordinary travel route, after checking an intention of the driver.

First, the necessity for automatic driving control in which a driver intention is reflected is described in the following.

Even if a vehicle is an automatically drivable vehicle, to make control in which a driver intention is reflected possible is necessary in order to perform flexible travel control.

In a case where a driver drives a vehicle to travel by manual driving, the driver makes various determinations at any time. On the other hand, development of an automatic driving controlling system which uses AI (artificial intelligence) having advanced ability to make determinations that makes it possible for a vehicle to automatically travel safely in various situations aiming at implementation of full automatic driving in which a person does not intervene with driving is under way.

Surrounding objects that interact with an automatic driving vehicle have a wide variety including pedestrians, other vehicles, and so forth, and correct determination for each of the objects is demanded.

On the other hand, it is necessary as a society to see the development of technology from the point of view of change in behavioral psychology of a human being when automatic driving is in widespread use in the world. In future development of the automatic driving technology, it is necessary to take into consideration not only control based on the behavioral psychology of a driver or other road users but also the behavioral psychology of a human being in the future that possibly changes together with the widespread use of automatic driving vehicles in the future.

It is estimated that, if automatic driving vehicles become common, also the behavioral psychology of human beings around them changes.

If attention is paid to the behavioral psychology of human beings, as a person, that have continued changing in the process of long evolution to date, it is found that various determinations are made every day in a diverse risk balance including social situations and that a behavioral psychology of a person is formed unconsciously. Life including human beings has been inherited to this day by taking fixed risks through a long evolution process. Life is sustained in various forms basically by normally self-selecting risks of survival across generations and getting to bait or avoiding becoming a prey, and has evolved and survived by taking such risks.

In other words, even if all risk determinations are not necessarily connected directly to the behavioral psychology of taking the risks for life support, human beings nowadays repetitively perform risk determinations for taking over the life everyday unconsciously. It is to be noted that a unique action of a person is sometimes a regional characteristic such as a culture or a moral of people.

Risk determinations made by persons also form more mechanisms as those for a group or a society and achieve continuous development and evolution in selection of fixed risks. In other words, life activities cannot be maintained if a certain risk is not chased. Persons congenitally have natural behavioral characteristics of putting something into an action even if any kind of risk is to be taken. A change associated with a risk is a basic mechanism equipped to life prior to thinking.

In particular, in an action pattern of a person in the society, risk balance is a significant factor in a relationship with others (including a behavior of a machine). In other words, it can be regarded that the action principle of risk avoidance forms a smooth society.

There is a possibility that settings that do not take a risk into consideration may cause a significant problem.

For example, if it should be determined that an automatic driving vehicle is not dangerous at all to any surrounding life, then some person will jump out in front of an automatic driving vehicle or will sit in front of an automatic driving vehicle. Also it is projected that not only a person but also a cat, a dog, or a livestock will interfere with the course of an automatic driving vehicle regardless of its approach.

Further, although risks to the driver of an automatic driving vehicle are also reduced by use of a vehicle for automatic driving or semi-automatic driving, there is a possibility that the driver may believe that fixed safety is secured even if the driver takes some other risks against the safety secured by functions of the vehicle and may perform bold travel using automatic driving.

As a result, there is a possibility that a significant change may be brought also to the behavioral psychology of a human being, which is a symbol of the evolution. Although a manual driving vehicle driven by a human being is basically controlled in accordance with traffic rules by its driver, the driver does not absolutely follow the traffic rules and will instantly determine the best action of the driver him/herself in a risk balance to decide an action.

Suppose that the system is set such that, when, as a result of an action determination based on the risk balance of actions of a human being, control of an automatic driving vehicle gives rise to the possibility of an interaction, for example, collision, of the automatic driving vehicle with an amount of oncoming vehicles, a pedestrian, or the like, which are other road users, the automatic driving vehicle takes all responsibility. If an automatic driving vehicle is introduced into the society on this premise, then human beings will think that, in any situation, it is possible to place all blames on the automatic driving vehicle.

As a result, the risk balance persons have had so far is lost, and there is a possibility that a road user such as a manual driving vehicle or a pedestrian may take such an action as to obstruct the course of an automatic driving vehicle without hesitation unless the road user is to take such a risk as penalties. Naturally, if forceful interruption or the like is performed, then there is a possibility that this may cause a secondary damage, and in this case, although there is a possibility that penalties such as punishment may be applied, it is estimated that the possibility of direct connection of an influence of the punishment to an instantaneous action determination is low and the effect of the penalties on suppression of an obstructive act to an automatic driving vehicle is poor.

However, if there is a risk determination that, in a case where the course of an automatic driving vehicle is obstructed, there is a possibility that a danger similar to that by a conventional manual driving vehicle may occur, then it is expected that the behavioral psychology to refrain from an obstructive act works.

If it is recognized that all approaching automatic driving vehicles perform vehicle control in which prevention of an accident is set to top priority, then the possibility that a manual driving vehicle or a person around any automatic driving vehicle may perform such an act as to suddenly interrupt the vehicle or jump out in front of the automatic driving vehicle becomes high. If a human being thinks that the risk has decreased, then the human being performs an action that involves a certain new risk. This is because selection of an action taking a risk in the process of evolution survival is an inevitable characteristic for survival and also is the source of inquiry and curiosity.

As an example of formation of a risk balance in a road use environment, for example, the following examples are available.

A driver who drives at a high speed has danger awareness felt sensuously by him/herself and feels a risk that the driver will be penalized in a case where the driver violates the speed, and reduces the travel speed according to the magnitude of the risk.

As a factor a driver sensuously determines dangerous, a road shape, clearance of the visibility by weather, a road surface situation such as a snow cover, an approaching situation of surrounding parallel traveling vehicles, and so forth are available, and the driver unconsciously determines such various risks as just described to decide a travel speed, an inter-vehicular distance, and so forth.

If it is made possible also for an automatic driving vehicle to perform control having risk balance similar to such risk balance of manual driving as described above, then it can be expected that a manual driving vehicle or a person around the automatic driving vehicle will refrain from such an act as to suddenly interrupt or jump out in front of the automatic driving vehicle. Although the possibility of occurrence of such problems as described above is not necessarily self-evident, it is also significant not to have a countermeasure after such problems have developed to a social subject but to design precautionary automatic driving, and the present disclosure is a technology necessary for cooperative control of automatic driving and other road environment users.

If even an automatic driving vehicle suitably executes control in which an intention of a user is reflected, then a human being is involved in vehicle operation at a fixed ratio.

In particular, for example, when plural vehicles pass the same interval, such a process as to perform adjustment or transfer of a priority rank in travel becomes possible. In other words, negotiation that takes risk balance into consideration can be implemented.

In order to perform such a process as just described efficiently and swiftly, required is a system which can efficiently execute intention reflection of a person in automatic driving vehicle. In other words, an interface for reflecting an intention of a person while automatic driving is continued without causing the person to fully return to cumbersome manual driving (HMI: Human Machine Interface) is required. Here, “fully return to manual driving” presupposes normal manual driving in which the driver sits on the driver's seat in a conventional manual driving vehicle.

If automatic driving control in which an intention of a driver who is a user is reflected is executed smoothly in an automatic driving vehicle and seamless cooperative control between the automatic driving controlling system and the driver is executed, then also such processes as, for example, described below are possible.

For example, when such an event that a road is blocked occurs, the possibility that the automatic driving controlling system may merely perform standby and stopping control on the basis of rules is high. By this control, a large number of vehicles will be connected in a row on the road and cause traffic jam. If a vehicle is controlled according to an intention of a driver before such a situation as just described occurs, then it is also possible to avoid traffic jam.

By making it possible to suitably allow intervention of an intention of a driver while automatic driving is continued in such a manner, the necessity for switching to manual driving is eliminated, and also the load on the driver is moderated.

For switching from automatic driving to manual driving, predetermined transfer time is required, and smooth countermeasure becomes difficult.

Further, in a case where vehicles block a road as a result of rule-based control, it is necessary for one of the vehicles to move back or the like in order to make a way, and a large-scale follow-up countermeasure is required. In such follow-up countermeasure processes, follow-out coping time is required in order to make it possible to allow vehicles pass through the road interval blocked by the automatic driving. As a result, the use efficiency of the road as a social infrastructure is deteriorated, making an inhibiting factor of social activities themselves.

As described so far, when an automatic driving vehicle is introduced to the society, if everything is left to the automatic driving controlling system that performs safety control on a full rule basis and intention reflection of a user is disabled, then there is a possibility that travel obstruction or the like by a surrounding vehicle or person occurs.

Further, there is a possibility that also cooperative vehicle travel that was available by conventional manual driving such as to yield the road to a different vehicle such that the different vehicle is permitted to go ahead to secure passing of the own vehicle may become unavailable.

Now, a specific configuration required as a mechanism for actually implementing cooperative control of an automatic driving controlling system and a user (driver) is considered.

For example, in a case where plural vehicles pass through one interval, a mechanism for allowing a vehicle to issue a request for transfer of travel priority and allowing another vehicle to accept the transfer request and approve actual transfer is required.

In a case where the own vehicle follows a planned course in a road situation that changes every moment in a society that uses automatic driving vehicles, if conflict occurs with a different vehicle that passes the same interval, then this makes a cause of blocking the road.

A vehicle that may limit travel of a different vehicle in a certain interval, for example, declares in advance a transfer request for travel priority for the interval. It is effective to perform pre-negotiation for avoiding such a risk that, when the different vehicle intrudes into the interval, the vehicle will block the road by following the road.

In processing of the present disclosure, when such a process as just described is performed, checking the intention of the driver or the like is executed.

Generally, most of the roads we use are roads built in the old days as roads that are needed for social activities. Also there are many roads for which excessive traffic of cars is not presupposed, but such roads are used in day-to-day life. Roads that can be expanded are some main highways while many other roads are used as they are. For main highways or the like, road expansion and maintenance for smoothening social activities have been performed to this day.

In such a road environment as just described, roads are used under the assumption that a vehicle or a person follows rules for performing social activities smoothly. In the present circumstances, various road environments are mixed in terms of the road width, presence/absence of a priority road, and so forth.

In an old narrow street, if an own vehicle stands by at a spot at which a vehicle coming from one direction can be moved sideways and allows a certain progress of the opponent vehicle, then the vehicles can progress without blocking their courses.

However, if the own vehicle proceeds with its progress ignoring arrival of the other vehicle at an evacuation spot and does not wait for the other vehicle to move to the evacuation place, there is a possibility that both vehicles may block the progress in a narrow interval, resulting in failure in progress.

Mutual concessions of a road can occur in various scenes. In addition, which one of the vehicles in that case should yield the road can change in various ways depending upon the situation at that time. Further, there sometimes appear a situation in which standby of the own car can prevent blocking of the road and there sometimes is a case in which, if the other user yields the road and the own car advances, then smooth interval passage of both of them can be achieved.

Such various situations frequently arise depending upon a complicated preceding/following relation. In a manual driving vehicle, the driver will first pay precautionary attention on the basis of visual information projected from a preceding vehicle or the surroundings and sometimes transfer a priority rank to a different vehicle at a point of time at which the driver feels that the risk that the own vehicle may block the road is high.

It is considered that, where a person precisely determines a complicated and versatile situation in such a manner, a more flexible diverse determination can be made.

It is to be noted that, although an automatic driving controlling system performs identification of a surrounding situation with use of various sensors, for example, there sometimes is a case in which the position of a different vehicle can be checked only through a gap between buildings or objects, and there also occurs a situation in which the situations intertwined in a complicated manner cannot necessarily be determined correctly from a higher point of view.

Although it would be ideal if an automatic driving controlling system for a vehicle is implemented in such a configuration that it mutually cooperates with vehicles traveling around the vehicle and manages control information including obstacle information around the individual vehicles in an integrated manner, it is not easy to implement a mechanism that allows all vehicles to normally provide information around the own vehicles to and from peripheral vehicles, in a mixed environment with non-automatic driving vehicles.

Accordingly, it is desirable that, even while automatic driving is being used, if a person feels the necessity, the person be made possible to perform vehicle control according to an intention of the person. For example, it is made possible to perform a travel priority rank changing request and so forth according to an intention of a person.

By making it possible to reflect an intention of a person directly in control of an automatic driving vehicle in such a manner, smooth vehicle movement is implemented.

The configuration of the present disclosure implements a control configuration that can easily execute cooperative automatic driving control where a driver inputs, even during automatic driving, an intention of adjustment of the priority travel right according to a relative situation with surrounding vehicles or continuation or stop of travel to an automatic driving controlling system.

By this configuration of the present disclosure, not only the driver is released from cumbersomeness in returning to manual driving but also occurrence of various problems that may possibly be caused by control only of an automatic driving controlling system, for example, such various problems as a road being blocked, a traffic jam being caused, or a vehicle being obliged to move back, can be prevented.

Also in regard to a relationship with a vehicle that is nothing but one of technologies used by the humankind, the relationship with a different road user actually depends upon mixture of many gains and losses from a situation in which a vehicle is used and a social situation of a use region of the vehicle. Normally, in a case where a vehicle is used under social rules or in a stable social situation, in many scenes encountered during movement with the vehicle, by traveling according to standards determined by traffic rules and so forth in the region, a person uses the vehicle in movement of articles without stagnation and with the safety kept at a fixed level or more.

Although one of moving means with which the risk is lowest is to walk, in modern times, the society that is a great mechanism does not function if transportation means such as vehicles are not used. In the civilized society nowadays, movement of a person or an object is performed between continentals or further up to the universe, and the human beings function as a form of large life of society by accepting a fixed risk. A person who is a social participant does not select to sit and starve to death but behaves instinctively selecting some kind of risk. Naturally, a person sometimes receives the assistance of others exceptionally depending upon more complicated abstract “risk” balance of an ethical aspect of the social morals and an emotional aspect.

However, the risk determination required of users in automatic driving of a vehicle is much different. Further, automatic driving control of an automobile is very much different in situation from automatic steering of an aircraft or the like. A pilot of an airplane receives repeated training for various abnormal situations in regard to an apparatus, meteorological conditions, and so forth, and besides, the target of the interaction is equipment or a climate situation, and steering does not very much change the action of the other party.

On the other hand, in the case of a vehicle, the other parties to be taken into consideration when automatic driving control is to be performed include a manual driving vehicle and a human being such as a pedestrian, and thus, a unique countermeasure is required. In particular, it is necessary to control a vehicle while normally interacting with other road users such as pedestrians and oncoming vehicles around the vehicle.

Since the other party to be taken into consideration when automatic driving control is to be performed is life, while a fixed risk is taken, risk balance is taken to start an action. If an automatic driving vehicle is not provided cooperatively with a determination of its user in any situation and stops without fail even by operation of an emergency brake and further stops even if it is disturbed by a pedestrian, without harming the pedestrian, the domineering pedestrian may sometimes have a risk determination psychology of forcibly crossing the road, and a risk of suffering a harm in a society or a district with worsened security can sometimes occur. Further, for wild monkeys that flock to a vehicle of a tourist and beg for food, the vehicle stopping in response to a monkey jumping out in front of the vehicle can be a convenience mechanism.

In particular, in order to perform, by an interaction as usual of an automatic driving vehicle with many other “road users,” mutual concessions of a road and avoidance of disturbance on the basis of a fixed risk determination action by both of them, a mechanism in which rule-based control uniform to a system is not performed but a user performs intervention in a certain precise determination is considered a useful countermeasure against the subject described above.

Together with introduction of automatic driving, a road user can enjoy the benefit of fixed risk reduction by safe-oriented travel control of an automatic driving vehicle. However, a person has a behavioral psychology to take a new risk until the reduced risk reaches a level similar to that of the original risk.

This is the risk homeostasis theory advocated in the field of the traffic psychology.

By making it possible to normally execute not only safety-oriented travel control of an automatic driving vehicle but also control in which an intention of a driver is reflected, it is possible to cause also a different road user to recognize that an automatic driving vehicle has a risk similar to that of a manual driving vehicle, and the effect of preventing intentional disturbance or a criminal activity by a surrounding vehicle or pedestrian can be expected.

As described above, an automatic driving vehicle does not stop without fail on the basis of rules, and control is performed in different manners depending upon the reflection of an intention of an automatic driving vehicle user.

In a case of viewing this issue from the side of a road environment user such as a pedestrian around an automatic driving vehicle, even in a case where the pedestrian performs course obstruction of the automatic driving vehicle, the automatic driving controlling system does not secure emergency stop without fail on the basis of rules. If a risk to a road environment user such as a pedestrian is left in such a manner, such a thoughtless act of a pedestrian as to cross the immediately front position of an automatic driving vehicle without hesitation can be given up.

Further, by making it possible to reflect a driver intention in an automatic driving controlling system even if the driver him/herself does not physically interfere with the steering system by manual driving, also such an advantageous effect as described below can be achieved. For example, upon driving in an interval requiring reflection of a driver intention, in order to cause the automatic driving controlling system to perform control in which a driver intention is reflected, the driver will monitor a traveling state. As a result, an advantageous effect is achieved that, even upon automatic travel, the driver is urged to pay fixed attention.

### 4. Specific Examples of Automatic Driving Control in which Intention of Driver is Reflected

Now, specific examples of automatic driving control in which an intention of a driver is reflected are described.

### 4-1 (Working Example 1) Example of Travel Control when Intruding Vehicle into Road Through which Automatic Driving Vehicle is Passing Appears

First, an example of travel control when an intruding vehicle into a road through which an automatic driving vehicle is passing appears is described.

In ordinary traffic rules, between a passing vehicle on a main street and a passing vehicle on a narrow street on which the traffic volume is small, in a situation in which no traffic signal exists, the vehicle on the main street has priority.

It is a rule that a vehicle that tries to intrude into a main street from a narrow street should travel such that it does not disturb travel of vehicles on the main street.

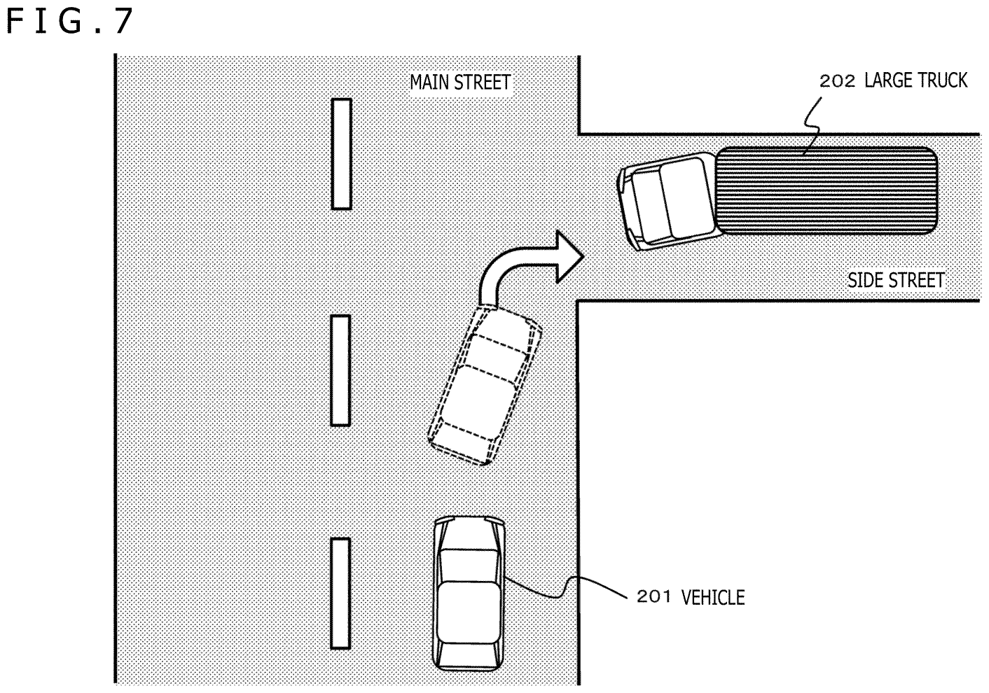

For example, as depicted in FIG. 7, while a vehicle 201 is traveling on a main street, it tries to turn right to a side street. From the side street, a large truck 202 tries to intrude into the main street and turn left.

According to the Road Traffic Act, the travel priority belongs to the vehicle 201 that is traveling on the main street.

However, in the case where the large truck 202 tries to intrude into the main street from the narrow side street and turn left as depicted in FIG. 7, it is projected that, if the vehicle 201 starts the right turn to the side street, then both the vehicle 201 and the large truck 202 are bought into a state in which they are unable to move.

If the vehicle 201 is a manual driving vehicle and the driver of it is an experienced driver, then the driver can perform such smooth travel that the driver stops the vehicle 201 at a point of time at which the driver catches sight of the top of the large truck 202 from the side street and then stands by as the large truck 12 completes the left turn and, after the standby, the driver starts the vehicle 201 and intrudes into the side street.

In the configuration of the present disclosure, in a case where the vehicle 201 is an automatic driving vehicle, the automatic driving controlling system of the vehicle 201 executes, according to an intention of the driver of the vehicle 201, vehicle-to-vehicle communication with the large truck 202 to perform an adjustment process (negotiation) for the travel priority. In particular, the automatic driving controlling system executes such control as to decide which one of the vehicles is to have the travel priority and to cause the vehicle from which the travel priority is transferred to stop and stand by.

It is to be noted that, in a case where the large truck 202 is an automatic driving vehicle and travel by its automatic driving controlling system is being executed, the automatic driving controlling system of the vehicle 201 performs an adjustment process (negotiation) for the travel priority with the automatic driving controlling system of the large truck 202.

In a case where the large truck 202 is a manual driving vehicle, the automatic driving controlling system of the vehicle 201 notifies the large truck 202 of a message and stands by until the driver responds.

It is to be noted that, when the automatic driving controlling system of the vehicle 201 performs such processes as described above, it checks an intention of the driver and performs a process according to the intention of the driver. For example, after checking with the driver that the travel priority may be transferred to the other vehicle, it performs the process of transferring the travel priority to the other vehicle.

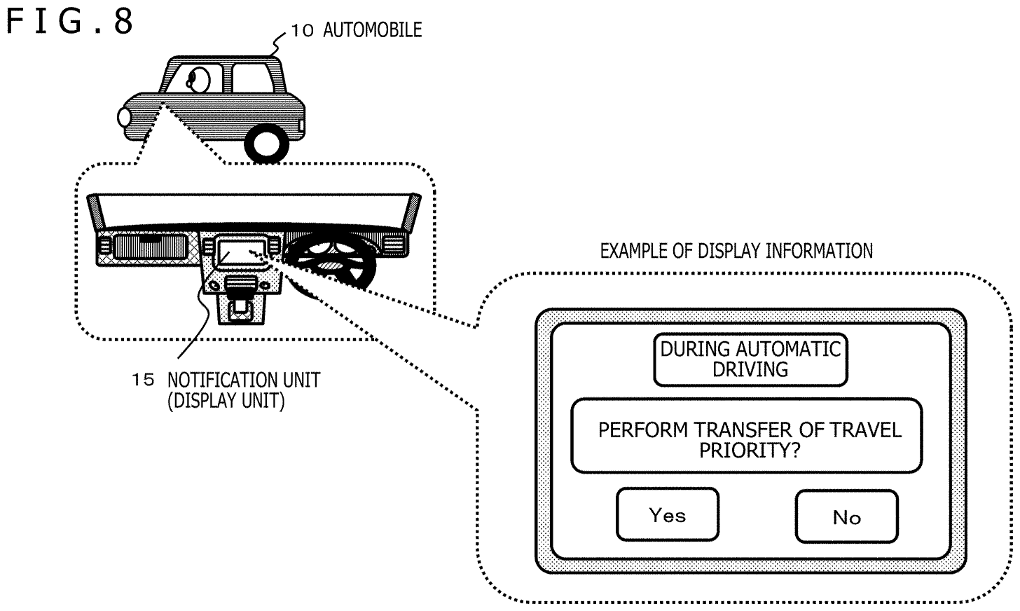

For example, in a case where such information as depicted in FIG. 8 is presented and the driver gives a response of Yes, the automatic driving controlling system starts an adjustment process (negotiation) for transfer of the travel priority to the large truck 202.

It is to be noted that the intention inputting of a user (driver) can be executed not only by a configuration that uses such a UI as depicted in FIG. 8 but also by inputting using a switch, a button, or the like, aural inputting through a microphone, inputting using a touch panel provided on the display unit, inputting by a gesture, and so forth.

By performing travel control in which an intention of a user (driver) is reflected in such a manner, the travel priority can be transferred to the large truck 202 that intrudes into the main street from the side street and that has low travel priority according to the original traffic rules. By this travel priority transfer process, a process for causing the vehicle 201 to stand by on the main street while the large truck 202 intrudes into the main street similarly as in a process in manual driving can be performed.

In order to execute the process just described, it is necessary that a vehicle having low priority performs information transmission for priority transfer request to a vehicle having high intruding travel right and then transfer of approval of the travel priority case is executed subject to agreement (handshake) of the automatic driving controlling systems of the two vehicles.

After the transfer approval of the travel priority case, each vehicle will perform automatic driving control such as a stopping or standby process or the like under the control of its automatic driving controlling system.

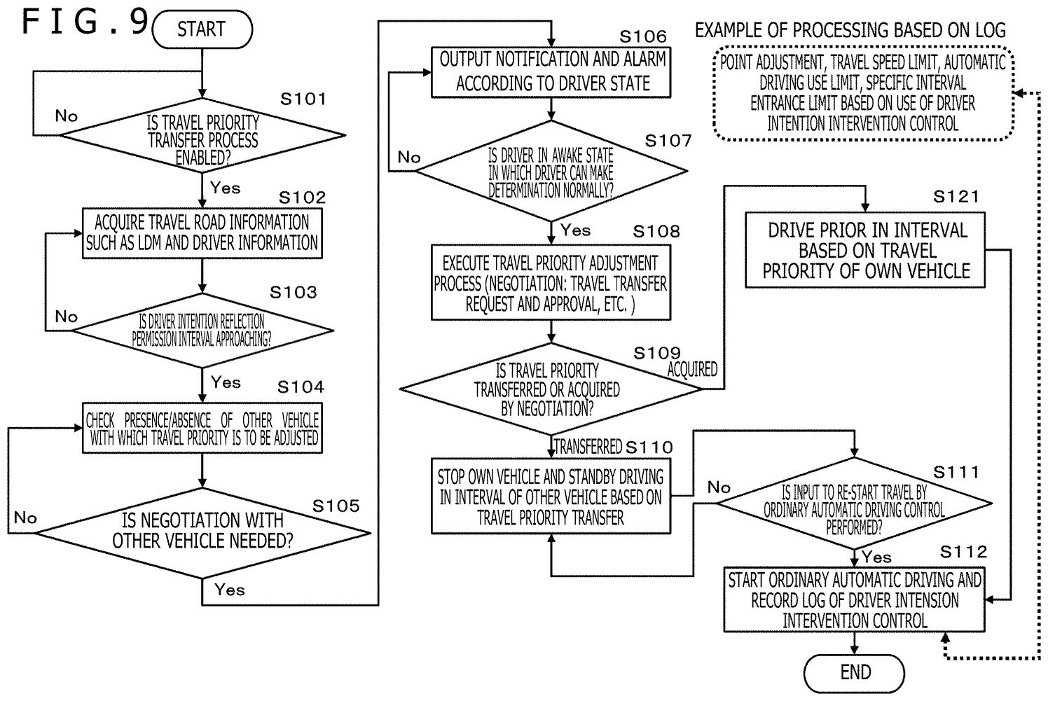

A processing sequence executed by the data processing unit of the automatic driving controlling system of the vehicle 201 is described with reference to a flow chart depicted in FIG. 9.

It is to be noted that processes based on the flow charts of FIG. 9 and so forth can be executed in accordance with a program stored in the storage unit, by the data processing unit of the automatic driving controlling system.

In the following, processes in steps of the flow chart depicted in FIG. 9 are described sequentially.

### (Step S101)

First, the data processing unit determines in step S101 whether or not the travel priority transfer process is enabled.

This process is an intention checking process for a user (driver or the like), and in a case where, for example, the UI depicted in FIG. 8 is presented and the user indicates an intention for enabling the travel priority transfer process, processes in steps beginning with step S102 are executed.

In a case where the user does not indicate an intention for enabling the travel priority transfer process, travel based on ordinary automatic driving control, that is, automatic driving control that prioritizes the safety, is performed.

### (Step S102)

In a case where it is determined in step S101 that enabling of the travel priority transfer process is performed, processes in steps beginning with step S102 are executed.

In step S102, the data processing unit acquires travel road information of a local dynamic map (LDM) and so forth and driver information.

As described hereinabove, the LDM is advanced environmental map information capable of being acquired, for example, from an external server and is information including current traffic situation information and so forth. The driver information is information acquired by the driver information acquisition unit 12 described hereinabove with reference to FIG. 1. For example, the driver information includes information for determining the degree of wakefulness of the driver, operation information of the driver, and so forth. In particular, the driver information is information acquired, for example, by the camera for capturing a face image of the driver and operation information acquisition units for acquiring information regarding operation of the individual operation units (steering wheel, accelerator, brake, and so forth).

### (Step S103)

Then, the data processing unit determines whether or not a driver intention reflection permission interval is approaching. For example, in a case where approach of an interval by which, for example, such a situation as depicted in FIG. 7 is exhibited is detected, the processing advances to step S104.

### (Step S104)

In step S104, the data processing unit checks presence/absence of another vehicle with which the travel priority is to be adjusted.

For example, in the example of FIG. 7, in a case where the own vehicle is the vehicle 201, the other vehicle with which the travel priority is to be adjusted is the large truck 202.

### (Step S105)

In step S105, the data processing unit determines whether or not adjustment of the travel priority with the other vehicle is needed.

For example, on the narrow street into which the own vehicle 201 is to intrude from now on, the large vehicle 202 is present. Although the large vehicle 202 does not have the priority to come out to the main street first, the vehicle 201 temporarily stands by on the narrow road of the turn right destination to wait that all passing vehicles on the main street pass by. As a result, the large vehicle 202 blocks the intruding vehicle (vehicle 201) from passing through the narrow street. If it is autonomously determined only from information of the surrounding information detection sensors without performing adjustment of the travel priority that there is no obstacle in the immediately preceding traveling direction and the own vehicle continues to steadily progress by automatic driving to an exit of the narrow road where the large vehicle stands by until it starts intruding into the narrow street, then arises the situation that the large vehicle 202 blocks the narrow road and the own vehicle cannot pass through the narrow road. In short, even if the vehicle 201 that is passing through the main street for which the vehicle 201 has the priority travel right progresses on the basis of the rule-based priority and detects that, only after arriving at a position indicated by a broken line, at which the exit of the narrow street is blocked, the right turn travel road ahead is blocked by the large vehicle 202, at this stage reached, both of the vehicles block the road mutually. Both of the vehicles are placed in a state in which they cannot advance any more. Thus, in a case where there is a risk of blocking a road, a checking process is performed before this situation arises. The LDM or the like may have only risk information such that an advance risk notification is issued to the driver. If it is determined in step S105 that performance of adjustment of the travel priority is needed, then the processing advances to step S106.

### (Step S106)

In step S106, the data processing unit first executes notification and alarming according to the driver state.

Since the vehicle is executing automatic driving, there is a case in which, for example, the driver is asleep or is absorbed in a secondary task such as a TV or a game, and there is a possibility that the driver may not at all look ahead.

The data processing unit of the automatic driving controlling system acquires such states of the driving vehicle from the driver information acquisition unit 12 and performs alarming and notification according to the states. In particular, the data processing unit issues a notification that such approaching of an oncoming vehicle as depicted in FIG. 7 has occurred.

### (Step S107)

Then, in step S107, the data processing unit determines whether or not the driver is in an awake state in which the driver can make normal determinations. In a case where the data processing unit determines that the driver is in an awake state in which the driver can make normal determinations, the processing advances to step S108.

### (Step S108)

The data processing unit of the automatic driving controlling system performs, in step S108, vehicle-to-vehicle communication with the other vehicle to execute a travel priority adjustment process (negotiation). In particular, the data processing unit executes an adjustment process regarding whether the travel priority is to be transferred to the other vehicle or to be acquired by the own vehicle.

### (Step S109)

In a case where, as a result of the travel priority adjustment process (negotiation) in step S108, the travel priority is transferred to the other vehicle, the processing advances to step S110. In a case where the travel priority is acquired by the own vehicle, the processing advances to step S121.

### (Step S110)

In a case where, as a result of the travel priority adjustment process (negotiation) in step S108, the travel priority is transferred to the other vehicle, in step S110, the data processing unit stops the own vehicle and stands by as the opponent vehicle passes the interval.

### (Step S111)

Then, in step S111, the data processing unit determines whether or not inputting of designating re-starting of ordinary automatic driving control travel is performed by the user (driver).

### (Step S112)

In a case where it is determined step S111 that the user (driver) has made inputting of designating re-starting of ordinary automatic driving control travel, in step S112, the data processing unit re-starts ordinary automatic driving control travel and records log information relating to the driver intention intervention control into the storage unit in the information processing apparatus or the storage unit of the management server.

This log information relating to the driver intention intervention control is information regarding what kind of driver intention intervention control is executed, and such a process, for example, as depicted on the upper right side of the flow of FIG. 9 is performed on the basis of the log information.

In particular, point adjustment such as addition or subtraction of a point based on use of the driver intention intervention control, limitation of the travel speed, limitation of automatic driving use, limitation of intrusion into a specific interval, and so forth are executed.

For example, in a case where transfer of the travel priority is performed by intervention of the driver intention, a point is added. On the other hand, in a case where transfer of the travel priority is not performed by the intervention of the driver intention, such point adjustment as a subtraction process of a point is executed.

Note that it is sufficient if such addition points are associated with events in general that give an incentive for prompting the driver to execute intention intervention, and they need not necessarily be linked to specific advantageous factors or disadvantageous factors in a limited manner. An example of effective point adjustment is to limit the use range of automatic driving, for example, according to acquired points. It is considered that such a point adjustment process as just described exhibits, to an automatic driving user, an effect that the consciousness of the user is kept in the vehicle during automatic travel.

Further, in a case where transfer of the travel priority is not performed or in a case where driver intention intervention control is abused, limitation of the travel speed, limitation of automatic driving use, limitation of specific interval intrusion, or the like is executed.

### (Step S121)

In a case where, as a result of the travel priority adjustment process (negotiation) in step S108, the own vehicle acquires the travel priority, the data processing unit executes passing of the interval first on the basis of the travel priority of the own vehicle in step S121.

Thereafter, the processing advances to step S112 in which the data processing unit re-starts ordinary automatic driving control travel and then records log information relating to the driver intention intervention control into the storage unit of the information processing apparatus or the storage unit of the management server.

As described so far, even during automatic driving, the driver can transfer the traffic priority for a road. Further, even in a case where the driver does not have the priority, the driver can request for the priority according to the user intention. By such processes as described above, the risk of blocking a road that is a social infrastructure can be reduced. It is to be noted that such a negotiation as described above can be executed on the basis of information based on the LDM, information of a direction indicator or the like of an approaching vehicle, or information obtained through vehicle-to-vehicle communication in advance. Alternatively, the system may perform risk estimation in advance to ask the user for a determination as to whether or not negotiation is to be executed.

### 4-2 (Working Example 2) Example of Control that Performs Flexible Countermeasure Against Existing Traffic Rules

Now, as a working example 2, an example of control for taking a flexible countermeasure against existing traffic rules is described.

For example, in a case where a vehicle travels in an insecure area, if the vehicle is stopped carelessly, then the vehicle is sometimes involved in a crime.

In such an area as just described, if a vehicle is stopped according to a stop line or a traffic signal in an intersection by following rules prescribed by the Road Traffic Act, for example, by 100%, then the risk that the vehicle suffers from robbery or the like increases.

In a case where an automatic driving vehicle travels in such an area as described above, control for stopping in compliance with rules, for example, such travel as stopping at a red traffic signal light or slowing down in a case where a pedestrian (suspicious person) approaches, according to the intention of the driver and prioritizing passing through the interval at a predetermined speed is performed.

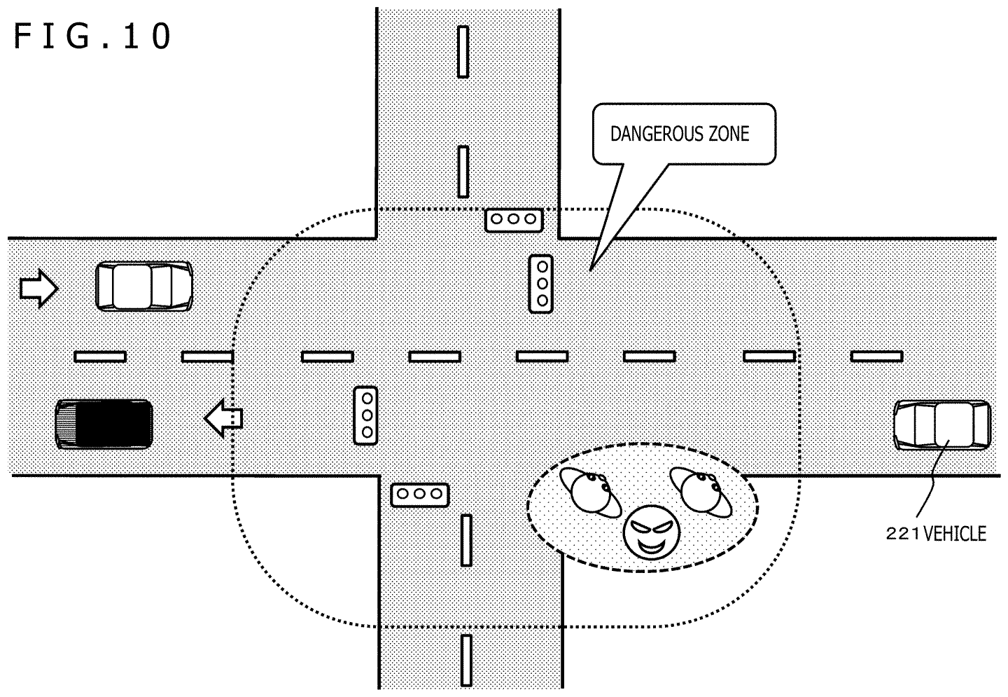

A particular example is described with reference to FIG. 10.

A vehicle 221 is an automatic driving vehicle. The vehicle 221 tries to pass through a dangerous zone that is a crime-ridden area. In a case where a traffic signal in the dangerous zone is red, if the vehicle 221 follows rules prescribed by the Road Traffic Act, then the vehicle 221 will, for example, stop, and the automatic driving controlling system performs stopping control.

However, a user (driver) who recognizes that the region is a dangerous zone knows that, if the vehicle stops, then the possibility that the vehicle may suffer from robbery or the like is high. In this case, the intention of the user (driver), that is, the intention that the driver hopes to travel without stopping within a specific interval such as a road interval or the like existing in a dangerous zone or the like, is conveyed to the automatic driving controlling system.

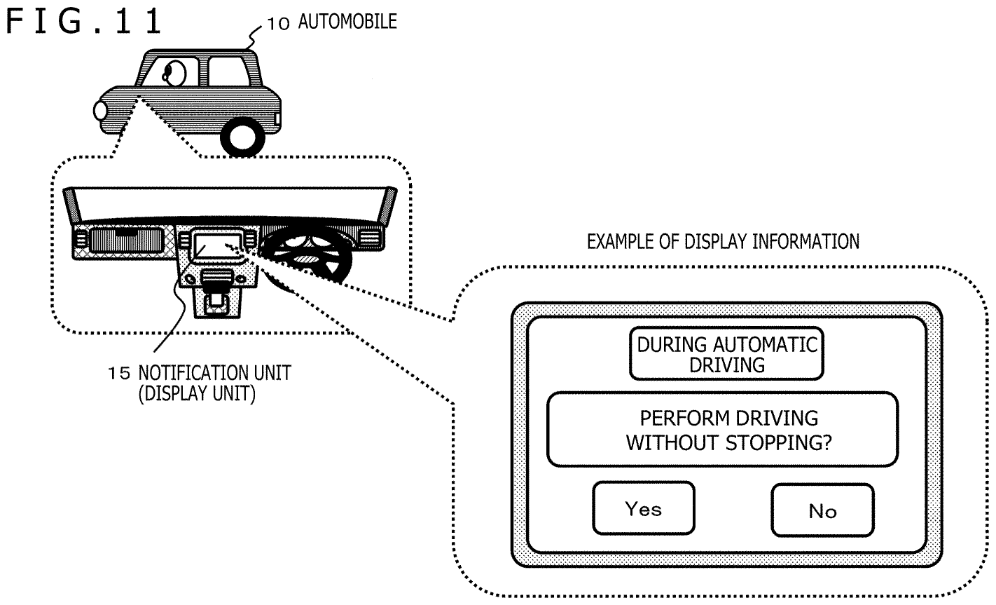

The user (driver) will convey the intention of the user (driver) to the automatic driving controlling system through such a UI, for example, as depicted in FIG. 11. The automatic driving controlling system performs control for traveling without stopping in a specific interval such as a road interval in a dangerous zone or the like according to the intention of the user (driver).

It is to be noted that the intention inputting of a user (driver) can be executed not only by a configuration that uses such a UI as depicted in FIG. 11 but also by inputting using a switch, a button, or the like, aural inputting through a microphone, inputting using a touch panel provided on the display unit, inputting by a gesture, and so forth.

It is to be noted that, although vehicle control that does not follow rules prescribed by the Road Traffic Act may seem reckless, this is effective to avoid a crime in a case where there is a risk that the vehicle suffers from a crime.

There are many cases in which a person unfamiliar with an overseas assignment stops a vehicle in an insecure area and suffers from a crime, and control for instantly determining that the vehicle passes through a dangerous zone and causing the vehicle to pass on the basis of an intention of the driver according to a situation is preventive measures for preventing the vehicle from being involved in a crime. Further, if it is known to the perpetrator side that it is common control that even an automatic driving vehicle does not stop according to the driver intention, then the psychology of easily aiming at a vehicle because the vehicle is an automatic driving vehicle is suppressed. In short, the fact itself that the automatic driving controlling system has a user intention reflection function gives rise to a crime prevention effect.

However, chaotically permitting vehicle control that deviates from rules for an automatic driving vehicle is not preferable from the point of view of compliance with the traffic rules. Accordingly, it is preferable to provide such a limitation that such a process is permitted only under certain conditions.

For example, vehicle control that deviates from the traffic rules is under such a limitation that it is permitted only in a specific region such as a crime-ridden area or only at night.

It is necessary that such special vehicle control is not abused as far as possible, and it is preferable to perform log storage and so forth of use records with use of a mechanism with which falsification of records can hardly be made and to provide such a system that evaluation of the use ratio in a unit of a driver on the basis of logs is performed.

### 4-3 (Working Example 3) Example of Control that Performs Flexible Countermeasure for Avoiding Risk Such as Traffic Jam

Now, as a working example 3, an example of control in which a flexible countermeasure is taken for avoiding a risk such as a traffic jam is described.

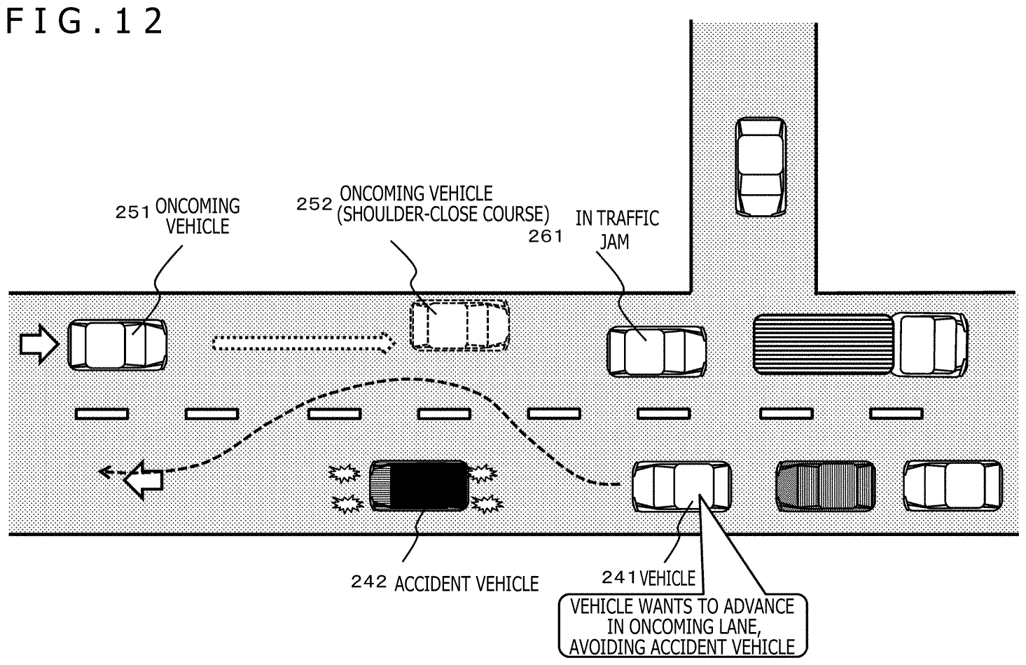

For example, in such a situation as depicted in FIG. 12, that is, during traveling of a vehicle 241 that is an own vehicle, the vehicle 241 encounters an accident-failure vehicle 242 in a stopping state. It is assumed that the road has one lane on each side, and in the Road Traffic Act, outstrip is inhibited.

In this case, if the vehicle 241 steadily continues safety-oriented automatic driving control, then it will stop in front of the accident-failure vehicle 242 and stands by until movement of the accident-failure vehicle 242 by a wrecker or the like is completed in compliance with the traffic rules. Alternatively, even if such a setting that a vehicle protrudes to an oncoming lane due to an accident car is permitted, in a case where any vehicle comes on a counter slanting line from the opposite direction, the accident-failure vehicle 242 will continue the standby.

If such a standby process is performed, then a traffic jam of following vehicles occurs.

In this situation, in order to overtake the accident vehicle, the user (driver) would indicate his/her intention to the automatic driving controlling system such that travel on the oncoming lane is performed.

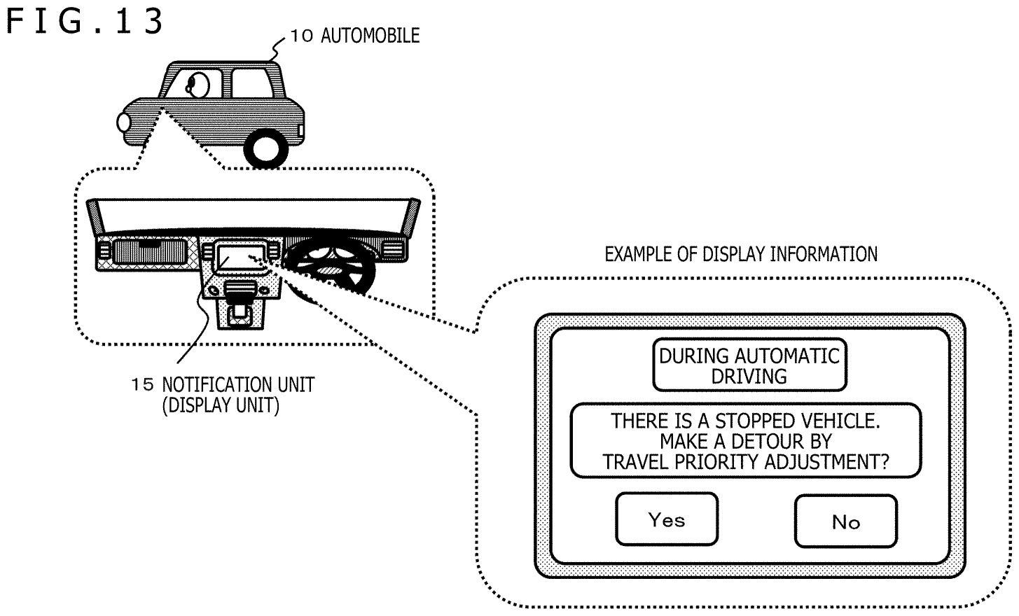

The intention of the user (driver) is conveyed to the automatic driving controlling system through such a UI, for example, as depicted in FIG. 13. The automatic driving controlling system starts detour travel according to the intention of the user (driver). However, in a case where a vehicle that is traveling on the oncoming lane, that is, for example, an oncoming vehicle 251 depicted in FIG. 12, is present, adjustment of the travel priority (negotiation) executed in the processes of FIGS. 7 to 9 described hereinabove is executed to perform alternate travel by concessions avoiding collision. For example, it is assumed that, as depicted in FIG. 12, the oncoming vehicle 251 approaching from the oncoming lane is present and a stopped vehicle 261 in a traffic jam stops on the oncoming lane. In this case, the oncoming vehicle 251 will stop in the rear of the stopped vehicle 261 in the traffic jam, and the vehicle 241 suffers difficulty in protruding to and traveling on the oncoming lane. In such a case as just described, adjustment of the travel priority (negotiation) is performed in advance between the vehicle 241 and the oncoming vehicle 251. Before the oncoming vehicle 251 approaches the accident vehicle 242, adjustment of the priority (negotiation) is performed to acquire the right to advance into the oncoming lane.

If automatic driving travel that suitably and cooperatively reflects an intention of a user (driver) in such a manner is performed, then occurrence of a traffic jam can be avoided. By making it possible to perform cooperative type control in which a driver intention is reflected based on a situation determination by the driver without returning to manual driving by the user while automatic driving control is continued in such a manner, efficient use of the social infrastructure is implemented.

### 5. Sequence of Processing Executed by Moving Apparatus and Information Processing Apparatus of Present Disclosure

Now, a sequence of processes executed by the moving apparatus and the information processing apparatus of the present disclosure is described.

The moving apparatus and the information processing apparatus of the present disclosure make control in which an intention of a user (driver) is reflected effective for the automatic driving controlling system as described hereinabove.

The intention of the user (driver) changes greatly depending upon the situation. In particular, during vehicle travel, various situations such as those described hereinabove with reference to FIGS. 7, 10, 12, and so forth occur, and the automatic driving controlling system checks the intention of the user (driver) according to each situation and performs travel control in which the intention of the user (driver) is reflected.

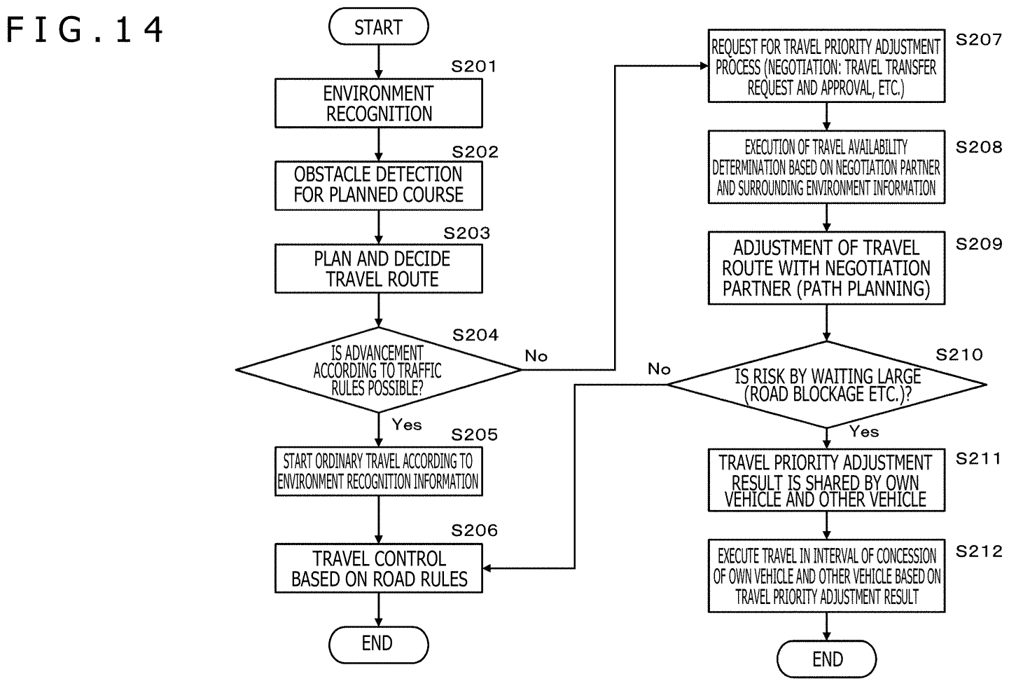

A typical example of a travel controlling sequence in which an intention of a user (driver) is reflected is described with reference to a flow chart depicted in FIG. 14.

Processes in steps of the flow chart depicted in FIG. 14 are processes executed by the data processing unit of the automatic driving controlling system.

In the following, the processes in the steps of the flow chart depicted in FIG. 14 are described sequentially.

### (Step S201)

First, the data processing unit of the automatic driving controlling system executes an acquisition process for environment information in step S201.

For example, the data processing unit performs an acquisition process for travel road information of the local dynamic map (LDM) or the like and for environment information by using the environment information acquisition unit 13 depicted in FIG. 1.

As described above, the environment information acquisition unit 13 acquires travel environment information of the automobile. For example, the environment information acquisition unit 13 acquires image information of the front, rear, left, and right of the automobile, position information by the GPS, surrounding obstacle information from the LiDAR (Laser Imaging Detection and Ranging) or the sonar, and so forth.

### (Steps S202 to S204)

Next, in step S202, the data processing unit detects an obstacle on the travel route on the basis of the environment information acquired in step S201.

For example, the data processing unit detects an own vehicle and so forth.

Further, in step S203, the data processing unit plans and decides a travel route to avoid the obstacle detected in step S202.

In the next step S204, the data processing unit determines whether or not the travel route determined in step S203 is a route along which the vehicle can travel in compliance with the traffic rules.

For example, it is determined that the travel route described hereinabove with reference to FIG. 12, that is, a route along which the vehicle is to travel intruding to the oncoming lane in order to detour an accident vehicle, is a route that violates the traffic rules.

In a case where it is determined in step S204 that the travel route decided in step S203 is a route along which the vehicle can travel in compliance with the traffic rules, the processing advances to step S205.

On the other hand, in a case where it is determined that the travel route decided in step S203 is not a route along which the vehicle can travel in compliance with the traffic rules, the processing advances to step S207.

### (Steps S205 and S206)

In a case where it is determined in step S204 that the travel route decided in step S203 is a route along which the vehicle can travel in compliance with the traffic rules, the processing advances to step S205.

In step S205, the data processing unit starts/continues normal travel while analyzing environment recognition information.

In step S206, the data processing unit executes automatic driving based on ordinary automatic driving control in compliance with the traffic rules.

### (Steps S207 to S209)

On the other hand, in a case where it is determined that the travel route decided in step S203 is not a route along which the vehicle can travel in compliance with the traffic rules, the processing advances to step S207.

In step S207, the data processing unit requests the other vehicle to perform a travel priority adjustment process (negotiation) that is needed to perform travel that does not comply with the traffic rules.

For example, in the example described hereinabove with reference to FIG. 12, the data processing unit of the automatic driving controlling system of the vehicle 241 transmits a request for a travel priority adjustment process (negotiation) to the oncoming vehicle 251 that is traveling on the oncoming lane.

Further, in step S208, the data processing unit performs travel availability determination based on a situation of the other vehicle of the travel priority adjustment process (negotiation) and the surrounding environment information.

Further, in step S209, the data processing unit executes adjustment of a travel route with the other vehicle of the travel priority adjustment process (negotiation).

It is to be noted that, in the travel route adjustment, negotiation may be performed for deciding a detailed travel route in a case in which the oncoming vehicle 251 stays at its position depicted in FIG. 12 without advancing, a case in which the oncoming vehicle 251 yields the road in such a form that it proceeds closer to the shoulder so as not to block the road of the lane and moves and proceeds at a position 252 (shoulder-close course) indicated by a broken line arrow mark or in a similar case. The simplest configuration is a configuration that performs such control that, where the user of the oncoming vehicle 251 who has received the priority request recognizes that, if the oncoming vehicle 251 advances steadily, the oncoming vehicle 251 will obstruct the passing on the opponent lane, the user of the oncoming vehicle 251 stays at the position depicted in FIG. 12 without advancing until the preceding stopped vehicle 261 goes away.

What is significant in actual control is that a user who receives a request for negotiation precisely issues an instruction to the system on the basis of situation determination result and performs control. By making control in which a determination of a user is reflected possible in such a manner, even if many events with regard to which it is difficult for the automatic driving system to autonomously make by itself a determination and take a countermeasure are encountered, rapid countermeasures according to a user intention can be performed.

For example, in the example described hereinabove with reference to FIG. 12, by performing such a negotiation that the oncoming vehicle 251 progresses to and then stops at a position near to the shoulder (end) side of the road, the vehicle 241 can decide a travel route along which it intrudes a little to the oncoming lane and passes through the interval by avoiding the accident (failure) vehicle 242.

### (Step S210)

Then, in step S210, the data processing unit determines whether or not, if the vehicle does not stand by and steadily advances along a course decided on the basis of information within a range within which automatic driving can recognize, such a risk that the vehicle blocks the road (road blockage) is great, in a form in which the user intention is reflected.

In a case where it is determined that, even if the vehicle steadily progresses through the negotiation process on the basis of the user intention, there is no risk of blocking the road or the like, the processing advances to step S206 in which the data processing unit executes road rule-based travel control. The particular process in this case is a process for causing the vehicle to stand by in front of the own vehicle or the vehicle to move near to the shoulder to secure a space through which the oncoming vehicle is to pass by.

On the other hand, in a case where it is determined that, where a standby process such as stopping in front or the like is not performed, such a risk as to block the road is great, the processing advances to step S211.

### (Steps S211 and S212)

In a case where it is decided in step S210 that such a risk as to block the road (road blockage) is great, the processing advances to step S211.

In step S211, the result of the travel priority adjustment process (negotiation) is shared with the other vehicle.

Then, in step S212, the data processing unit executes travel in the concession interval of the own vehicle and the other vehicle on the basis of the result of the travel priority adjustment.

It is to be noted that the example described above is one working example and has been described as a working example in which a driver executes intention inputting and actual steering thereafter is performed automatically. In addition to this, similar other countermeasures are possible such as a countermeasure that, after it is determined by the determination made in step S210 that the vehicle is to stand by, if a situation in which return to manual driving of the driver is possible is restored during the standby, then a passage space of the oncoming vehicle is secured by user determination to perform travel by manual driving.

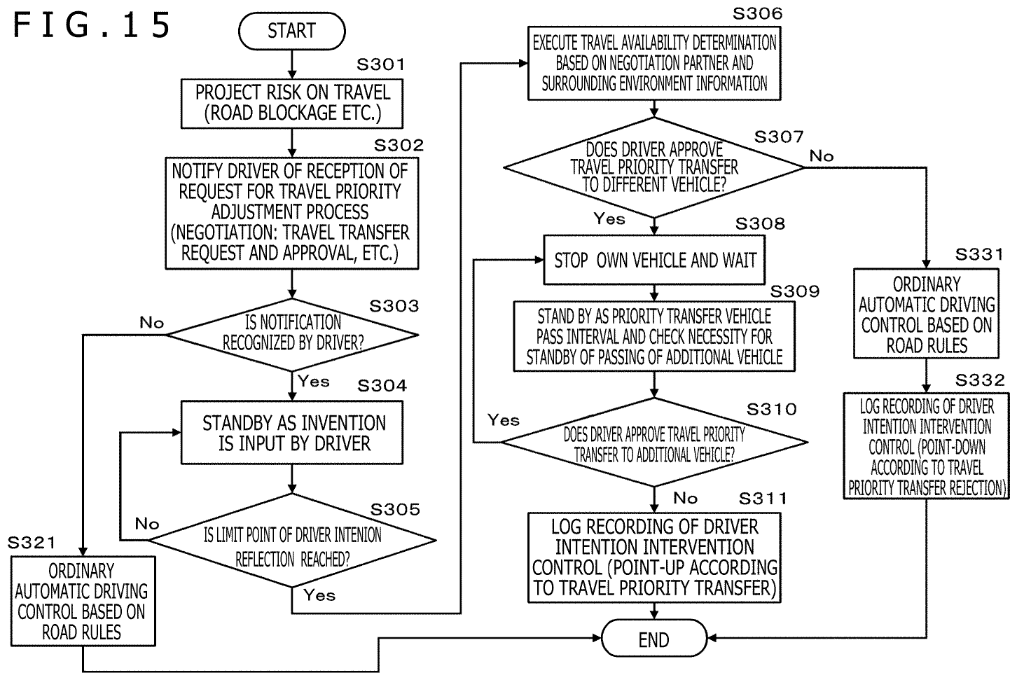

Now, with reference to the flowchart illustrated in FIG. 15, description is given of a series of processing sequences of intention checking for a user (driver) in a case where the automatic driving controlling system receives a travel priority adjustment process (negotiation) request, control based on the intention checking, and a log recording process.

Although the surrounding situation recognition performance of the automatic driving system has some kind of limitation, by introducing cooperative type control in which an intention of a user is reflected, it becomes possible to take a countermeasure against a complicated relation with vehicles, which is difficult for the surrounding situation recognition performance of the automatic driving system to identify. However, it is necessary for the user to receive a risk notification from the system at an early stage and precisely return an intellectual determination result according to the notification risk to the system. Depending upon whether or not a precise countermeasure is taken, it is decided whether the driver is to enjoy a benefit or is to suffer from a disadvantage. This develops the countermeasure determination ability of the user. Further, if a function of performing, in a case where the user takes a precise countermeasure, incentive point-up addition, but performing, in a case where the user does not take a precise countermeasure and gives rise to creation of an induced risk of road blockage, point-down of a penalty is performed, then a mechanism in which not only benefits but also disadvantages of other users of the traffic infrastructure are reflected can be configured.

Processes in steps of the flow depicted in FIG. 15 are described.

### (Step S301)

First, the data processing unit of the automatic driving controlling system projects a risk on travel (road blockage or the like) in step S301.

This process is executed using, for example, travel road information of the local dynamic map (LDM) and environment information acquired by the environment information acquisition unit 13 depicted in FIG. 1.

As described hereinabove, the environment information acquisition unit 13 acquires travel environment information of the automobile. For example, the environment information acquisition unit 13 acquires front, rear, left, and right image information of the automobile, position information by the GPS, surrounding obstacle information from the LiDAR (Laser Imaging Detection and Ranging), sonar, and so forth, and other information.

### (Steps S302, S303, and S321)

Then, in step S302, the data processing unit notifies the driver of reception of the travel priority adjustment process (negotiation) request.

In step S303, the data processing unit determines whether or not the notification is recognized by the user (driver).

For example, the data processing unit makes such determination by determining whether or not a response input of the user (driver) is received or by analyzing a gesture of the user (driver) or the like.

In a case where the data processing unit determines that the notification is not recognized by the user (driver), the processing advances to step S321, in which the data processing unit continues the automatic driving by normal automatic driving control.

On the other hand, in a case where the data processing unit determines that the notification is recognized by the user (driver), the processing advances to step S304.

### (Steps S304 and S305)

In a case where the data processing unit determines that the notification is recognized by the user (driver), the processing advances to step S304, in which the data processing unit stands by as an intention of the driver in regard to the reception notification of the travel priority adjustment process (negotiation) request is input.

In step S305, the data processing unit determines whether or not a limit point of driver intention reflection is reached, and if a limit point of driver intention reflection is reached, then the processing advances to step S306.

### (Step S306)

In step S306, the data processing unit performs travel availability determination on the basis of the situation of the other vehicle of the travel priority adjustment process (negotiation) process and the surrounding environment information.

### (Steps S307, S331, and S332)

Then, in step S307, the data processing unit determines whether or not the user (driver) agrees to transfer the travel priority to the other vehicle of the travel priority adjustment process (negotiation) process.

In a case where the user (driver) agrees to such transfer, the data processing unit executes processes in steps beginning with step S308.

In a case where the user (driver) does not agree to such transfer, the data processing unit executes ordinary automatic driving on the basis of the road traffic rules in step S331 and performs log recording of driver intention intervention control in step S332. For example, the data processing unit executes a point-down process in response to the rejection of the travel priority transfer.

### (Steps S308 to S310)

In the case where the user (driver) agrees to transfer the travel priority to the other vehicle of the travel priority adjustment process (negotiation) process in step S307, the data processing unit executes processes in steps beginning with step S308.

First, in step S308, the data processing unit causes the own vehicle to stop.

Then, in step S309, the data processing unit stands by as the priority transfer vehicle passes the interval and checks the necessity for standby of passage of an additional vehicle or vehicles.

Further, in step S310, the data processing unit determines whether or not the user (driver) approves transfer of the travel priority to the additional vehicle.

This particularly is a process in a case where the own vehicle permits also a following vehicle or vehicles that follow the other vehicle of the travel priority adjustment process (negotiation) process to pass first.

In this case, the standby process in step S308 is continued.

In a case where the following vehicle and so forth are interrupted, the processing advances to step S311.

### (Step S311)

In step S311, the data processing unit performs log recording of the driver intention intervention control. For example, the data processing unit executes a point-up process according to the travel priority transfer.

As described above so far, the moving apparatus and the information processing apparatus of the present disclosure make it possible for the automatic driving controlling system to execute automatic driving in which an intention of a user (driver or the like) is reflected as needed. Further, by combining this with a point or the like for providing an incentive to a user, a mechanism that promotes positive cooperation control and actual participation becomes possible, enabling seamless performance of a countermeasure in situations that interact intricately with each other.

By performing such control of an automatic driving vehicle as described above, an advantage brought about by driver determination that is exhibited in conventional manual driving is generated. In particular, smoothened traffic of a global infrastructure perspective is implemented.

Applying the process of the present disclosure gives rise to an advantageous effect of bringing about mutual benefits when the road infrastructures are shared and used such as prevention of a traffic stack on a narrow road or the like that is likely to occur by uniform rule-based automatic driving or appearance of a malicious vehicle or pedestrian who abuses limited behavior characteristics of automatic driving, the mutual benefits being different from travel advantages brought about solely of an automatic driving vehicle.

The advantageous effects by the process of the present disclosure include, for example, the following effects.

1. Also during automatic driving, cooperative control with a surrounding different vehicle becomes possible, and prevention or moderation of a traffic jam by smooth use of road infrastructures is implemented.

2. There is a prevention effect of a disturbing action, a crime, and so forth by abuse of automatic driving control by a third party.

3. There is also a prevention effect of abuse by a driver of intention intervention control, by log recording of the driver intention intervention control.

4. In comparison with a driving driver seat return request level as the automatic driving level 3 of the conventional SAE definition levels, the driver can perform rapid judgment intervention, and as a result, flexibility and rapid response according to the road situation can be realized.

### 6. Example of Configuration of Information Processing Apparatus

While the processes described above can be executed applying the configuration of the moving apparatus described with reference to FIG. 4, part of the processes can be executed, for example, by an information processing apparatus that can be removably mounted on the moving apparatus.

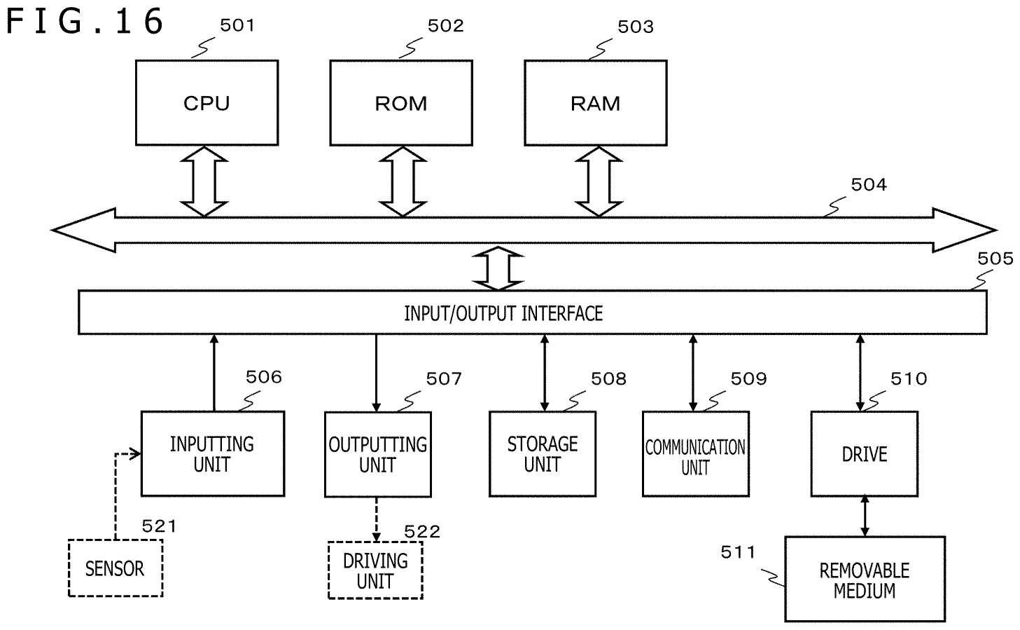

An example of a hardware configuration of such an information processing apparatus as just described is described with reference to FIG. 16.

FIG. 16 is a view depicting an example of a hardware configuration of the information processing apparatus.

A CPU (Central Processing Unit) 501 functions as a data processing unit that executes various processes in accordance with a program stored in a ROM (Read Only Memory) 502 or a storage unit 508. For example, the CPU 501 executes processes according to the sequences described hereinabove in connection with the working examples.

Into a RAM (Random Access Memory) 503, programs to be executed by the CPU 501, data, and so forth are stored. The CPU 501, the ROM 502, and the RAM 503 are connected to each other by a bus 504.

The CPU 501 is connected to an input/output interface 505 through the bus 504, and an inputting unit 506 including various switches, a keyboard, a touch panel, a mouse, a microphone, a situation data acquisition unit of sensors, a camera, a GPS, and so forth, and the like and an outputting unit 507 including a display, a speaker, and so forth are connected to the input/output interface 505.

It is to be noted that also input information from a sensor 521 is inputted to the inputting unit 506.

Meanwhile, the outputting unit 507 outputs also driving information for a driving unit 522 of the moving apparatus.

The CPU 501 receives an instruction, situation data, and so forth inputted from the inputting unit 506 as input thereto, executes various processes, and outputs a result of the processes, for example, to the outputting unit 507.

The storage unit 508 connected to the input/output interface 505 includes, for example, a hard disk or the like and stores programs to be executed by the CPU 501 and various kinds of data. The communication unit 509 functions as a transmission/reception unit of data communication through a network such as the Internet or a local area network and communicates with an external apparatus.

A drive 510 connected to the input/output interface 505 drives a removable medium 511 such as a magnetic disk, an optical disk, a magneto-optical disk, a semiconductor memory such as a memory card or the like and executes recording or reading of data.

### 7. Summary of Configuration of Present Disclosure

Working examples of the present disclosure have been described in detail with reference to the specific working example. However, it is apparent that those skilled in the art can make various modifications or alterations without departing from the spirit and the scope of the present disclosure. In other words, the present invention has been disclosed in the form of illustration and shall not be interpreted in a limited manner. In order to determine the subject matter of the present disclosure, the claims should be referred to.

It is to be noted that the technology disclosed in the present specification can have such configurations as described below.

(1) An information processing apparatus including:

a data processing unit that executes automatic driving control, in which

the data processing unit includes an inputting unit to which an intention of a user is inputted, and executes automatic driving control in which the intention of the user is reflected.

(2) The information processing apparatus according to (1), in which the data processing unit executes an adjustment process of travel priority between an own vehicle that is a control target by automatic driving and a different vehicle different from the own vehicle, on the basis of the intention of the user.

(3) The information processing apparatus according to (2), in which the data processing unit checks, before the data processing unit executes the adjustment process of travel priority, a transfer intention of the travel priority with the user.

(4) The information processing apparatus according to (2) or (3), in which the data processing unit determines, on the basis of an analysis of a travel environment, whether or not conflict in the same travel interval is to occur between the own vehicle and the different vehicle and executes, in a case where it is determined that conflict is to occur, the adjustment process of travel priority.

(5) The information processing apparatus according to any one of (1) to (4), in which the data processing unit executes control for performing travel without stopping in a specific interval with the intention of the user reflected.

(6) The information processing apparatus according to any one of (1) to (5), in which the data processing unit executes control for performing travel on an oncoming lane with the intention of the user reflected.

(7) The information processing apparatus according to any one of (1) to (6), in which the data processing unit executes, before start of travel on an oncoming lane, communication with an oncoming vehicle that travels on the oncoming lane and executes an adjustment process of travel priority between the own vehicle and the oncoming vehicle.

(8) The information processing apparatus according to any one of (1) to (7), in which the data processing unit

executes a user intention checking process and executes, in a case where a user intention is checked, automatic driving control in which the checked user intention is reflected, but

executes, in a case where a user intention is not checked, automatic driving control according to rules prescribed in advance.

(9) The information processing apparatus according to any one of (1) to (8), in which the data processing unit checks the intention of the user from at least any one of a switch operation, a touch panel operation, voice, or a gesture of the user.

(10) A moving apparatus including:

an environment information acquisition unit that acquires environment information of the moving apparatus; and

a data processing unit that executes automatic driving control, in which

the data processing unit determines a risk on a travel road according to the environment information acquired by the environment information acquisition unit, includes an inputting unit to which an intention of a user is inputted, and executes automatic driving control in which the intention of the user is reflected.

(11) The moving apparatus according to (10), in which the data processing unit executes an adjustment process of travel priority between an own vehicle that is a control target by automatic driving and a different vehicle different from the own vehicle, on the basis of the intention of the user.

(12) The moving apparatus according to (11), in which the data processing unit checks, before the data processing unit executes the adjustment process of travel priority, a transfer intention of the travel priority with the user.

(13) An information processing method executed by an information processing apparatus, in which

the information processing apparatus includes a data processing unit that executes automatic driving control, and

the data processing unit receives an intention of a user as input thereto and executes automatic driving control in which the intention of the user is reflected.

(14) An information processing method executed by a moving apparatus, in which

the moving apparatus includes
an environment information acquisition unit that acquires environment information, and
a data processing unit that executes automatic driving control, and

the data processing unit determines a risk on a travel road according to the environment information acquired by the environment information acquisition unit, receives an intention of a user as input thereto, and executes automatic driving control in which the intention of the user is reflected.

(15) A program for causing an information processing apparatus to execute information processing, in which

the information processing apparatus includes a data processing unit that executes automatic driving control, and

the program causes the data processing unit to receive an intention of a user as input thereto and execute automatic driving control in which the intention of the user is reflected.

Further, the series of processes described in the specification can be executed by hardware, by software, or by a composite configuration of them. In a case where the processes by software are executed, a program in which the processing sequence is recorded can be installed into a memory in a computer incorporated in hardware for exclusive use and be executed by the computer or can be installed into and executed by a computer for universal use that can execute various processes. For example, it is possible to record the program in advance in a recording medium. The program can not only be installed from the recording medium into the computer but also be received through a network such as a LAN (Local Area Network) or the Internet and installed into a recording medium such as a hard disk built in the computer.

It is to be noted that the various processes described in the specification may be carried out not only in a time series based on the description but also in parallel or in an individual manner depending upon the processing capacity of an apparatus that executes the processes or as occasion demands. Further, in the present specification, the term system is a logical aggregation configuration of plural apparatuses and is not limited to a configuration in which the component apparatuses are placed in the same housing.

### INDUSTRIAL APPLICABILITY

As described above, according to the configuration of the working example of the present disclosure, a configuration that receives an intention of a user as input thereto and executes automatic driving control in which the intention of the user is reflected is implemented.

In particular, for example, the data processing unit that executes automatic driving control receives, even during travel in an automatic driving mode, an intention of a user as input thereto as needed and executes automatic driving control in which the intention of the user is reflected. The data processing unit executes an adjustment process of travel priority between an own vehicle that is a control target by automatic driving and a different vehicle different from the own vehicle. The data processing unit determines, on the basis of analysis of a travel environment, whether or not conflict in the same travel interval is to occur between the own vehicle and the different vehicle and checks, in a case where it is determined that conflict is to occur, the transfer intention of travel priority with the user and then executes the adjustment process.

By the present configuration, a configuration that receives an intention of a user as input thereto and executes automatic driving control in which the intention of the user is reflected without return to manual operation by the user is implemented.

### REFERENCE SIGNS LIST

10: Automobile
11: Data processing unit
12: Driver information acquisition unit
13: Environment information acquisition unit
14: Communication unit
15: Notification unit
20: Driver
30: Server
100: Moving apparatus
101: Inputting unit
102: Data acquisition unit
103: Communication unit
104: Vehicle inside equipment
105: Output controlling unit
106: Outputting unit
107: Drivetrain controlling unit
108: Drivetrain system
109: Body controlling unit
110: Body system
111: Storage unit
112: Automatic driving controlling unit
121: Communication network
131: Detection unit
132: Self-position estimation unit
133: Situation analysis unit
134: Planning unit
135: Motion controlling unit
141: Vehicle outside information detection unit
142: Vehicle inside information detection unit
143: Vehicle state detection unit
151: Map analysis unit
152: Traffic rule recognition unit
153: Situation recognition unit
154: Situation projection unit
155: Safety determination unit
161: Route planning unit
162: Action planning unit
163: Motion planning unit
171: Emergency avoidance unit
172: Acceleration/deceleration controlling unit
173: Direction controlling unit
501: CPU
502: ROM
503: RAM
504: Bus
505: Input/output interface
506: Inputting unit
507: Outputting unit
508: Storage unit
509: Communication unit
510: Drive
511: Removable medium
521: Sensor
522: Driving unit

1. An information processing apparatus comprising:
a data processing unit that executes automatic driving control, wherein
the data processing unit includes an inputting unit to which an intention of a user is inputted, and executes automatic driving control in which the intention of the user is reflected.

2. The information processing apparatus according to claim 1, wherein the data processing unit executes an adjustment process of travel priority between an own vehicle that is a control target by automatic driving and a different vehicle different from the own vehicle, on a basis of the intention of the user.

3. The information processing apparatus according to claim 2, wherein the data processing unit checks, before the data processing unit executes the adjustment process of travel priority, a transfer intention of the travel priority with the user.

4. The information processing apparatus according to claim 2, wherein the data processing unit determines, on a basis of analysis of a travel environment, whether or not conflict in a same travel interval is to occur between the own vehicle and the different vehicle and executes, in a case where it is determined that conflict is to occur, the adjustment process of travel priority.

5. The information processing apparatus according to claim 1, wherein the data processing unit executes control for performing travel without stopping in a specific interval with the intention of the user reflected.

6. The information processing apparatus according to claim 1, wherein the data processing unit executes control for performing travel on an oncoming lane with the intention of the user reflected.

7. The information processing apparatus according to claim 1, wherein the data processing unit executes, before start of travel on an oncoming lane, communication with an oncoming vehicle that travels on the oncoming lane and executes an adjustment process of travel priority between an own vehicle and the oncoming vehicle.

8. The information processing apparatus according to claim 1, wherein the data processing unit
executes a user intention checking process and executes, in a case where a user intention is checked, automatic driving control in which the checked user intention is reflected, but
executes, in a case where a user intention is not checked, automatic driving control according to rules prescribed in advance.

9. The information processing apparatus according to claim 1, wherein the data processing unit checks the intention of the user from at least any one of a switch operation, a touch panel operation, voice, or a gesture of the user.

10. A moving apparatus comprising:
an environment information acquisition unit that acquires environment information of the moving apparatus; and
a data processing unit that executes automatic driving control, wherein
the data processing unit determines a risk on a travel road according to the environment information acquired by the environment information acquisition unit, includes an inputting unit to which an intention of a user is inputted, and executes automatic driving control in which the intention of the user is reflected.

11. The moving apparatus according to claim 10, wherein the data processing unit executes an adjustment process of travel priority between an own vehicle that is a control target by automatic driving and a different vehicle different from the own vehicle, on a basis of the intention of the user.

12. The moving apparatus according to claim 11, wherein the data processing unit checks, before the data processing unit executes the adjustment process of travel priority, a transfer intention of the travel priority with the user.

13. An information processing method executed by an information processing apparatus, wherein
the information processing apparatus includes a data processing unit that executes automatic driving control, and
the data processing unit receives an intention of a user as input thereto and executes automatic driving control in which the intention of the user is reflected.

14. An information processing method executed by a moving apparatus, wherein
the moving apparatus includes
an environment information acquisition unit that acquires environment information, and
a data processing unit that executes automatic driving control, and
the data processing unit determines a risk on a travel road according to the environment information acquired by the environment information acquisition unit, receives an intention of a user as input thereto, and executes automatic driving control in which the intention of the user is reflected.

15. A program for causing an information processing apparatus to execute information processing, wherein
the information processing apparatus includes a data processing unit that executes automatic driving control, and
the program causes the data processing unit to receive an intention of a user as input thereto and execute automatic driving control in which the intention of the user is reflected.
